(19) United States
(12) Patent Application Publication
(10) Pub. No.: US 2008/0294427 A1
(43) Pub. Date: Nov. 27, 2008

(54) Method and apparatus for performing a semantically informed merge operation

(75) Inventors: Hua Cheng, Bridgeville, PA (US); David A. Evans, Pittsburgh, PA (US); Jeffrey K. Bennett, Pittsburgh, PA (US); David A. Hull, Pittsburgh, PA (US); Yan Qu, Cupertino, CA (US); Carol L. Tenny, Pittsburgh, PA (US); Jesse A. Montgomery, Garland, TX (US); Ilya M. Goldin, Pittsburgh, PA (US)

Correspondence Address: JONES DAY, 222 EAST 41ST ST, NEW YORK, NY, 10017, US

(73) Assignee: JustSystems Evans Research, Inc., Pittsburgh, PA (US)

(21) Appl. No.: 11/802,173

(22) Filed: May 21, 2007

(51) Int. Cl. G06F 17/27

(52) U.S. Cl. 704/9

(57) ABSTRACT

A method and apparatus for performing an informed semantic merge operation comprises selecting a source region in a document and a target region in the same or a different document. A bi-directionally coupled surface region is identified in the source region and a bi-directionally coupled surface region is identified in the target region. A first semantic object coupled to the surface region in the source region is identified and a second semantic object coupled to the surface region in the target region is identified. The subcomponents of the first semantic object are combined with the subcomponents of the second semantic object by merging.

### BACKGROUND

The present disclosure is directed generally to information technology and, more particularly, to the use of semantic information for processing expressions found in documents, images, etc.

Employees of most modern organizations are often required to create various documents as records of their thoughts, activities, plans, etc. Ideally, these documents can be reused for creating new documents to save time and effort. Current document management systems provide limited functionality such as keyword based document search. The authors will need to weed through potential matching documents and manually manipulate sections of these documents to compose a new document using conventional text/file merge operations.

The text/file merge operation is realized as an Insert operation in most word processing programs, where the user could insert simple objects such as special symbols and page breaks, or complex objects such as files and pictures. The Insert operation consists of selecting a source object, and inserting it at the position of the current cursor. This operation is limited in many ways. It can only place the whole source at the insert position, which does not allow interaction between the source and target objects. However, sometimes the user might want to associate parts of the source with parts of the target. For example, the user may want to merge two tables showing different information about company personnel to form a table with unified information. Current technologies will let the user append the content of one table after the other, but will not unify information about the same person.

While there has been a great deal of work on semantic representations, on text mining, on the identification of entities and fact extraction, on text understanding and generation, there has been no development of a system that supports general information object (document) operations that are based on semantic principles. Thus, the need exists for a system and method for semantically anchoring surface expressions to an ontological model of semantic information, and for manipulating text having such semantically anchored expressions in ways informed by the semantic and ontological information.

### SUMMARY

The method and apparatus of the present disclosure are directed, in one embodiment, to a semantically informed merge operation comprising selecting a source region in a document and a target region in the same or a different document. A bi-directionally coupled surface region is identified in the source region and a bi-directionally coupled surface region is identified in the target region. A first semantic object coupled to the surface region in the source region is identified and a second semantic object coupled to the surface region in the target region is identified. The subcomponents of the first semantic object are combined with the subcomponents of the second semantic object by merging or appending.

The method and apparatus of the present disclosure are directed, in another embodiment, to a semantically informed merge operation comprising selecting one or more source regions in a document and a target region in the same or a different document, where the target region may or may not be one of the source regions. The system supports non-semantic merge (where the source and target regions do not contain bi-directionally coupled source regions, or where the target region otherwise does not support a semantic merge operation). However, in cases where a semantic merge is possible, the system must identify minimally compatible bi-directionally coupled surface regions in the source and target regions, then combine them by merging or appending. This merge or append must take into account the complex, recursive structure of CSOs to correctly process primitive, SO, and CSO components of the regions.

An advantage of the disclosed semantic merge is that when the user chooses a source to merge, the document management system will identify the semantic relevance of the source, and combine (through merging or appending) parts of the source with parts of the target. The merge result will also be formatted with respect to the constraints of the target region. Such an operation is more refined so that the user does not need to go through the content manually to make the necessary adjustment. Those advantages and benefits, and others, will be apparent from the description appearing below.

### BRIEF DESCRIPTION OF THE DRAWINGS

For the method and apparatus of the present disclosure to be easily practiced and readily understood, the method and apparatus will now be described, for purposes of illustration and not limitation, in connection with the following figures wherein:

FIG. 1 is an example of overlapping surface regions controlled by semantically anchored expressions;

FIG. 2 illustrates one example of an architecture of semantically anchored expressions;

FIG. 3 illustrates the local and remote components of one example of semantically anchored expressions;

FIG. 4 illustrates an ontologically complex event that contains activities and plain text;

FIG. 5 is a flowchart illustrating one example of a method for generating a semantically anchored expression;

FIG. 6 is a flowchart illustrating one example of a method for rendering a semantically anchored expression;

FIG. 7 illustrates a system within which the disclosed method may be practiced;

FIG. 8 is a flowchart illustrating one embodiment of a semantic replace operation according to the teachings of the present disclosure;

FIG. 9 is an example that schematically illustrates one embodiment of a semantic replace operation according to the teachings of the present disclosure;

FIG. 10 is another example of semantic replace in which co-references are changed as needed;

FIG. 11 is a flowchart illustrating one embodiment of a semantic update operation according to the teachings of the present disclosure;

FIGS. 12A and 12B are an example that schematically illustrates one embodiment of a semantic update operation according to the teachings of the present disclosure;

FIG. 13 is a flowchart illustrating a more general version of semantic replace that supports the replacement of multiple source and target semantic objects;

FIG. 14 is a flowchart illustrating one example of a semantically informed text operation, specifically the steps of a copy and paste operation;

FIGS. 15 and 16 illustrate schematically the process shown in the flowchart of FIG. 14;

FIG. 17 is a simplified view of the process shown in the flowchart of FIG. 14 with examples of what the various options in the menu might look like;

FIG. 18 illustrates the effect of semantic copy and paste in which copied material expresses previously unavailable information when pasted into a target region;

FIG. 19 is a flowchart illustrating one example of a semantic merge according to one embodiment of the present disclosure;

FIG. 20 is a flowchart illustrating the steps of one example of the default merge process shown in FIG. 19;

FIG. 21 is a flowchart illustrating the steps of one example of the Merge (SOⱼ, SRs, TR) process shown in FIG. 19;

FIG. 22 is a flowchart illustrating another example of a semantic merge according to another embodiment of the present disclosure;

FIG. 23 is a flowchart illustrating the steps of one example of the source merge process shown in FIG. 22; and

FIGS. 24, 25A, 25B, and 26 illustrate schematically various examples of the merge processes.

### DESCRIPTION

The method and apparatus of the present disclosure address the problems set forth above by anchoring surface regions encompassing words, phrases, and other surface expressions to semantic objects based on an ontology. In the example paragraph above, words like “Bill,” “Jane,” and “wife” can be semantically anchored to semantic objects which allow the computer to understand what those words mean, to the extent meaning can be found in either the semantic object or the ontology. By “semantically anchored” we mean that there is a bi-directional coupling of the surface regions which, from the user's perspective, appear as surface expressions, to the semantic object and of the semantic object to the surface region. The expression that appears in the region under Presentation (defined below) may be derived from the underlying semantic object, or may be completely arbitrary and user-defined. The association to the region exists independently of any particular surface expression that appears there. Before we can begin to explain the method and apparatus of the present disclosure, we should introduce a few terms. Note that the introduction of these terms is intended to provide context for the disclosed embodiments and to satisfy the best mode requirement. These terms, when used in the claims, should be broadly interpreted to the extent allowed by the prior art and not limited to the following definitions.

In this disclosure, we will be dealing with Information Objects (IOs). An IO is simply a source of information. An IO may encompasses images, graphical objects, audio files, and structured or semi-structured material, as well as text (with or without mark-up). An IO might be an entire document. An IO might be an “invisible” point, area of white space, etc. that is nevertheless able to be pointed to and described. A “point IO” is an information source—it has information about a location in a document. If the document is actually an audio file, an IO might be the part of the audio file where a particular word is spoken, or the “dead air” between words. One cannot enumerate or even unambiguously identify all potential IOs in a document because the IOs can be composed. For example, “John K Smith” could be an IO, but so could “John” and “K” and “Smith”, and the whitespace between the words, etc. There is a very large (though finite, due to storage granularity) number of potential IOs in a document.

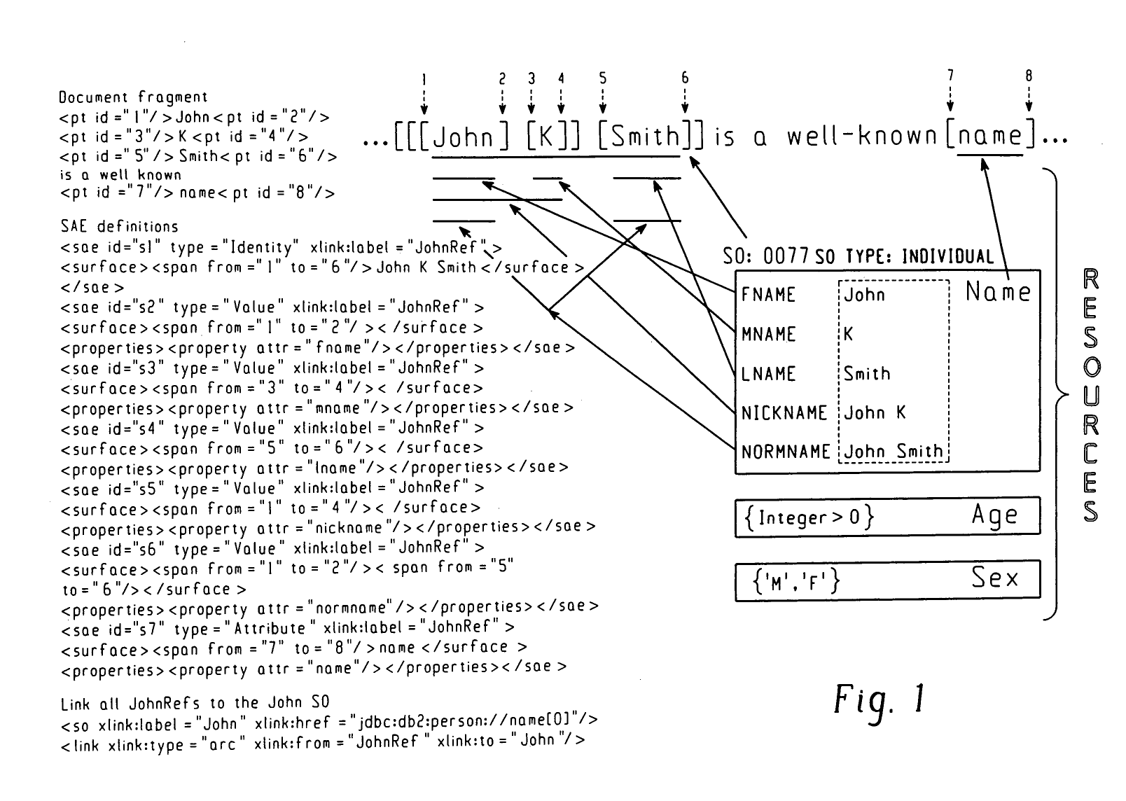

A surface region (or surface form) is the region of a document under the scope of a Semantically Anchored Expression (SAEs are defined below). The surface region may comprise a point, word, phrase, or location within the local document as well as contiguous and noncontiguous or even overlapping points, words, phrases, or locations within the local document. See FIG. 1 for an example of overlapping surface regions controlled by SAEs. The surface region is defined or selected at the time of creation.

A surface expression is the appearance of the surface region associated with an SAE at the time of presentation, i.e., runtime. The surface expression is the visual or behavioral result of a Presentation (Ps are defined below) interpreting an SAE. For example, in the case of Identity and Attribute types of SAEs, the surface expression at runtime will be congruent with the appearance of the surface region at the time SAE was authored, i.e., design time. But the expression could be different in different Ps. A company directory might appear as a list of names and extensions—but if the person viewing the document is a new hire, or unknown to the system, the P might additionally put pictures and phone numbers next to the names (and suppress that information for longer term employees).

An ontology is a specification of the structure of concepts in a domain of discourse. It may be convenient to think of an ontology as a model of some type of domain knowledge.

A Semantic Object (SO) is a named, typed, and structured entry in a data repository representing an entity and its associated set of properties (e.g., relations; attributes and values; other constraints and conditions). An SO is pointed to by one or more surface regions. The generation of the links that couple the surface region to the SOs is discussed in greater detail below. The properties of the SOs are determined to some extent by the ontology.

SOs have unique “types” that are apparent to or discoverable by the system. Ultimately, the lowest-level constituents are expressible as “primitive” types that can be processed by the system in standard ways (e.g., strings, integers, doubles).

An SO may have certain required attributes and possibly required values (i.e., specified, non-empty values), which represent the definitional (“analytic”) properties and relations of the SO, and an arbitrary number of optional or additional attributes and values (A-Vs), representing its contingent (“synthetic”) properties and relations.

For example, traditionally, the notion “human” includes, by definition, the property “mortal” and the attribute “age,” even if the value of age is not known in the case of a particular human. However, the property “married” is not required for the SO to be “semantically complete.” In the case of constructed knowledge representations, we are free to require arbitrary A-Vs in the SOs. For example, we may require that any SO in our data repository representing an employee must contain valid values for the attributes “Name” and “Social Security Number.”

SOs may have associated version numbers. When an SO is updated, the system may increment the version number, in accordance with standard industry practice and algorithms well known to practitioners of the art, such that previous versions remain accessible. The information associated with an SO may be stored in distributed data structures. An SO's version number may be incremented, for example, whenever any constituent component (or its relationship to other components) is changed.

An SO that is self-complete and cannot be decomposed into other SOs may be referred to as a primitive SO. A Complex Semantic Object (CSO) is an SO that depends on or consists of other SOs for its definition. A relatively straightforward example is a collective entity. For example, “The Gang of Four,” might be represented by an SO that has an attribute “Composed-of” with “value” given by a set of pointers to the four SOs representing the individual members of the Gang of Four.

A more complicated example is an ontologically complex concept, such as a “Sales Event.” This might be represented by an SO composed of one or more “Sales Activities,” which, in turn, are composed of one or more “Sales Actions.” Each of the (nested) substructures may be represented as distinct SOs in the system; each of these SOs may be composed of or point to yet other SOs (such as the SOs representing the location of the event, the individuals who participated, etc.).

A property of an SO may be any of the valid structures of an SO, including a system specific global unique identifier. As a practical matter, properties of an SO may serve as a cover term for any of the attributes, values, or relations of the SO, along with the SO's identity.

A Presentation (P) is a software module expressing a set of specifications of the format and other conditions necessary to render an SO for viewing by a user, including, for each presentation type, a list of the attributes and values (properties) that are required and how the information associated with the entities, attributes, and values is to be structured or combined with other information for display. A P is capable of rendering text, images, and other media types as required. Additionally, it contains a set of modules for expressing the content of SAEs. Minimally, a P would be capable of automatically generating data repository queries for Value-type SAEs, using information stored in the SAE or in data repository meta-data (e.g., the “key” property of a given SO). A P could also contain a set of modules for processing SAEs with named functional types.

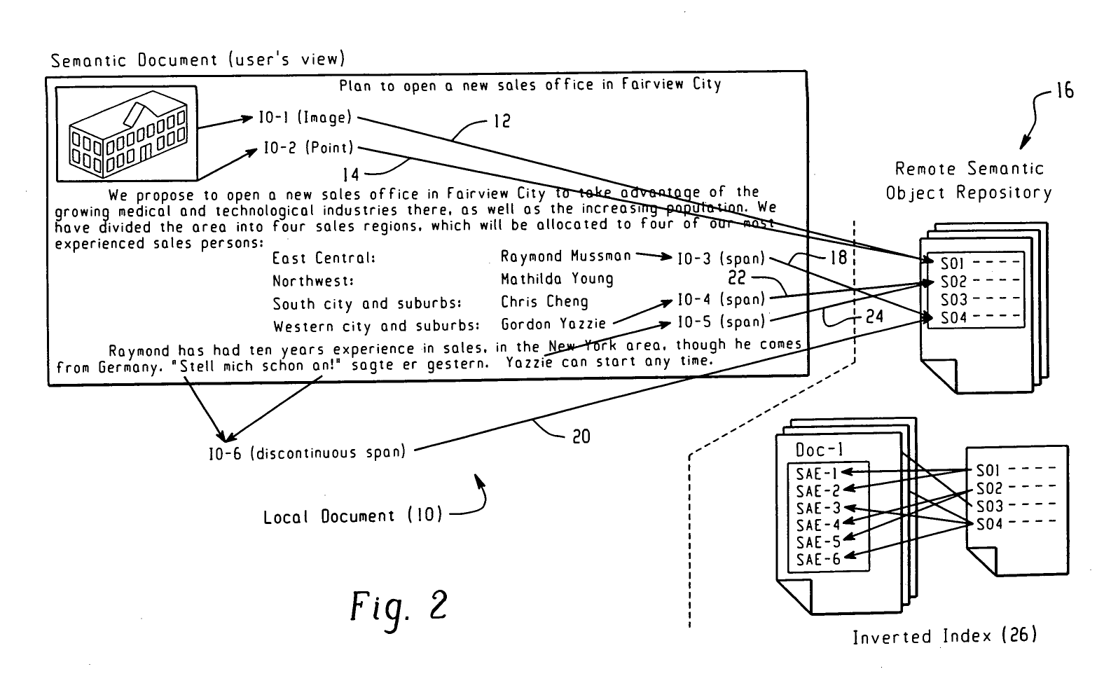

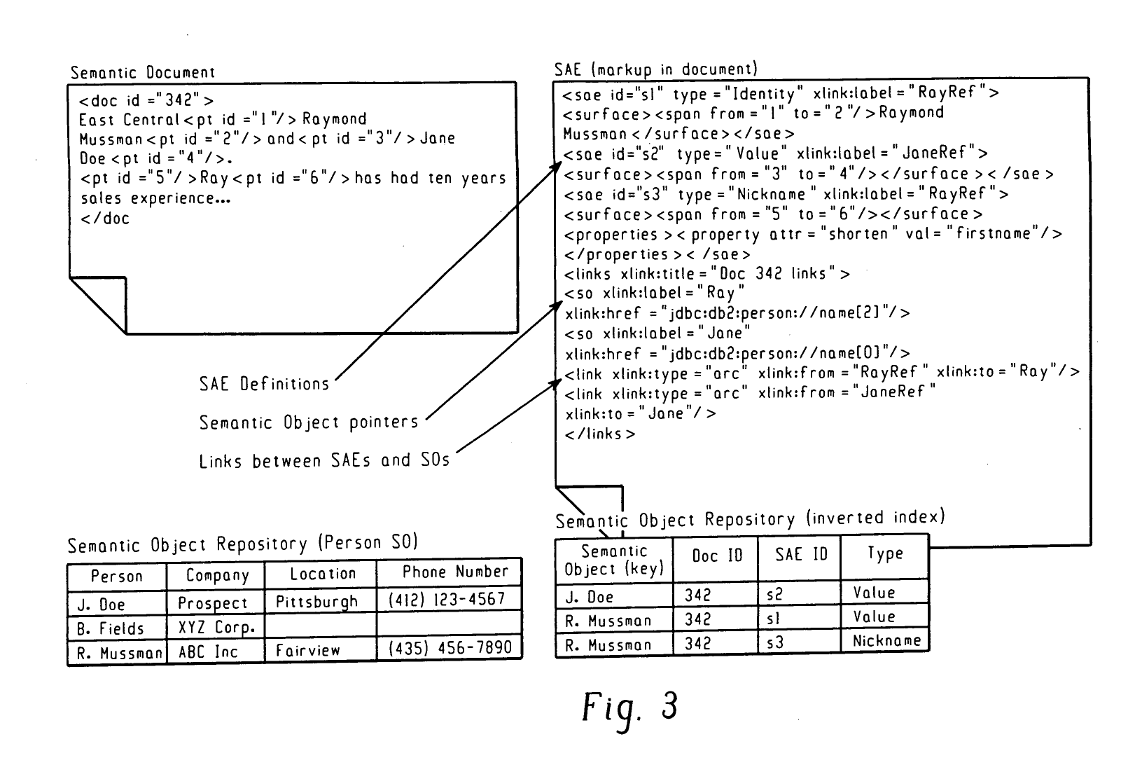

With those terms defined, we can now turn to FIG. 2 and a discussion of the architecture of a semantically anchored expression (SAE). In FIG. 2, consider the local document 10. A user has identified an image as Information Object 1 (IO-1) and a point IO-2 immediately following the image. These information objects are co-extensive with their surface regions. The surface regions are coupled via links 12, 14, respectively, to semantic object number 1 (SO1) stored in a remote semantic object data repository 16. SO1 may be of semantic type “facility.” See FIG. 3 for an example of the coding to implement this coupling.

The user has identified the surface region from just before the “R” to just after the “N” in “Raymond Mussman” as IO-3 and coupled it via link 18 to SO4 in the repository 20. SO4 may be of semantic type “PersonName.” The discontinuous surface region “stell”. . . “an!” is IO-6 that is coupled via link 20 to SO4. The IO-6 may have a function-type (“Expletive”) with supplementary data “Verb=anstellen.” See FIG. 3.

Finally, the surface regions that encompass “Gordon Yazzie” IO-4 and “Yazzie” IO-5 are coupled via links 22, 24, respectively, with SO2 which is an SO of the type PersonName. IO-4 is a Value type and IO-5 is an Attribute-type with the property “LastName=LAST.” See FIG. 3.

The links 12, 14, 18, 20, 22, and 24 provide a coupling between their respective surface regions and the SOs to which they are coupled. The semantic object repository 16 may contain, although it may be contained elsewhere, an inverted index 26. The inverted index 26 is basically a table for providing an association between each SO and each surface region which points to or is coupled with that SO. In that manner, a coupling is created from the SOs back to each surface region. This process of bi-directionally coupling a surface region and an SO is referred to as creating a semantically anchored expression.

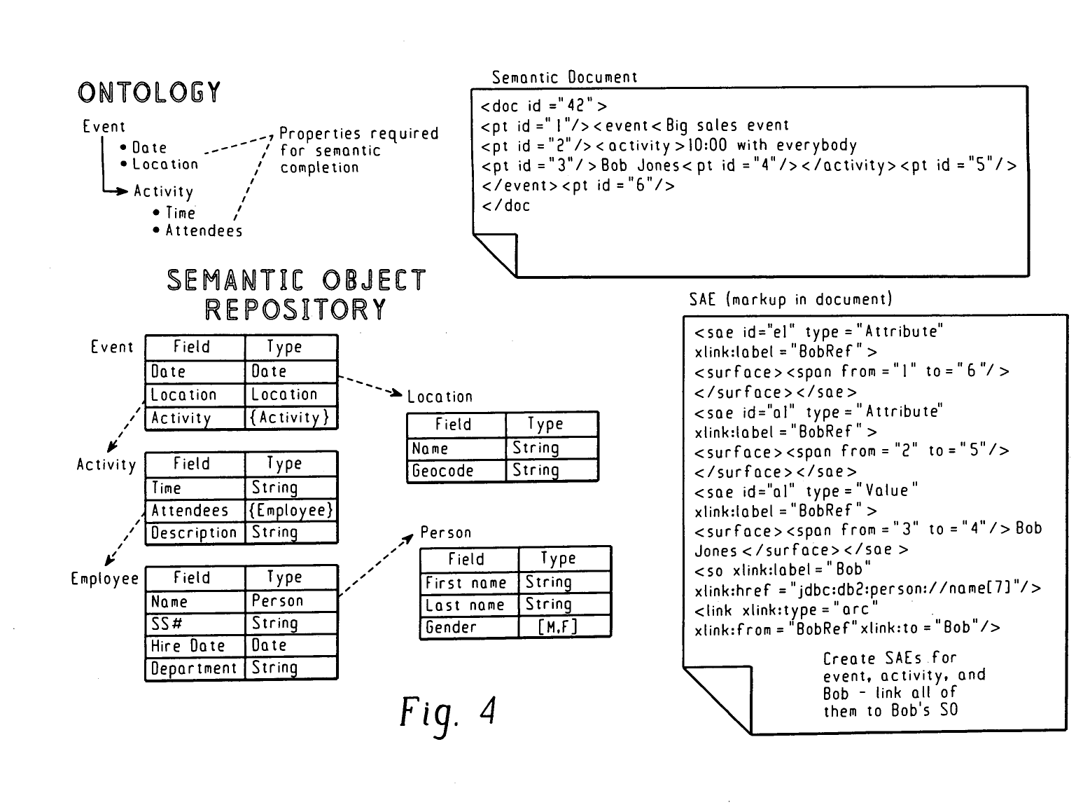

Upon encountering a functional type SAE and verifying that the module required for processing it is present, the P would invoke the module to render the SAE. The function invocation requires the region to be rendered, the SO(s) referenced by the SAE (or retrieved as a result of query processing), and possibly further refining parameters from the SAE properties or user input. Because CSOs contain other SOs, this is a recursive process. For example, FIG. 4 shows an ontologically complex CSO (an “Event”) that contains activities and plain text. The ontology specifies that Events require date and location fields to be semantically complete. Also, Activities require time and attendee fields, and Activities are related to events (in this case, by simple containment, though the ontology supports arbitrary relation types). The semantic object repository schematic shows how CSOs are built up from component SOs. Event type objects contain fields required by the ontology, plus a set of Activity objects. These, in turn, contain ontologically necessary fields, plus some optional fields (at the discretion of the particular implementation). Activities contain employee CSOs, which contain several fields including a person SO. The SAEs link the event region, activity region, and the name region to the Bob Person SO. It would also be possible to link regions to the Employee CSO, or to the Activity/Event CSOs. Regions could also be noncontiguous (e.g., the activity region could “skip” an area of free text).

From the foregoing, we can conclude the following about semantically anchored expressions (SAEs) in this embodiment. SAEs are expressions created by users or automatically and displayed through Ps. The appearance and behavior of SAEs under editing reflect the linked SO(s) in a semantically coherent manner, according to the relation expressed by the link(s), and constrained by the context provided by the P. (Note: appearance includes the “null” case where the SAE has no expression, visual or otherwise, and editing behavior includes the case where user modifications are prohibited.)

SAEs are coupled to one or more SOs by a persistent, explicit link stored locally with the local document. These links exist whether or not the document 10 in FIG. 2 is “open” or being viewed. Furthermore, the coupling is bidirectional: links from the document 10 to the repository 16 in one direction and by means of the inverted index 26 in the other direction. The inverted index 26 makes it possible to locate all SAEs in all documents that link to a particular SO, and all SAEs that link to a CSO containing or otherwise ontologically related to a particular SO. In general, the anchoring is accomplished through expressing the link in some query language that can uniquely identify and retrieve an SO from the data repository. For instance, the data repository may consist of an RDB with XML integration, accessible through the SPARQL or XQuery languages.

SAEs are semantic—the SO types, including their attributes and relations, are ultimately derived from an ontology. Anchoring ensures semantic identity, and the system ensures consistency of reference across the entire document collection. One SAE is referentially identical to another SAE if both SAEs are linked to all and only the same SOs. One SAE is referentially similar to another SAE if both SAEs are linked to at least one identical SO.

An SAE has the following (minimal) structure:

a surface region (word, phrase, point, etc.)—as it appears in the IO or document.

a link to one or more SOs (perhaps including the SO's version).

a type (e.g., one of the set {Identity, Attribute, Value}, or an arbitrary Functional type whose behavior is determined in large part by associated Ps). An Identity type SAE refers to (stands for) the entire SO. Conceptually, it is the SO in the context of a given document and P. An Attribute type SAE expresses an indirect relation to some aspect of an SO (e.g., when the reference is to the attribute itself rather than to its value), while a Value type SAE directly expresses some part of an SO (usually through generation of a surface form). A functional type SAE performs custom processing as defined by a P.

an association to enable all SAEs that link to an SO to be identified.

In general, the surface form, link, and type will be stored locally with the IO or document. The association and the SOs will generally be stored remotely.

When expressions are anchored semantically, changes to one part of a document (or to the underlying data repository) may propagate throughout the document collection in ways that are unexpected and may seem “miraculous”.

Some existing systems accommodate persistent links to resources (usually within the document, but occasionally from external sources). Changing the resource updates all the links (e.g., Word's mail merge, document fields, or OLE objects). However, bi-directional semantic couplings enable more powerful and surprising operations. Bi-directional semantic couplings enable a highly flexible indirection—typed links can refer to component parts or specific interpretations of underlying data objects, allowing the system to judge whether and how certain changes need to be propagated. So a replace or update may propagate to only a subset of the linked expressions, and may change their visual representation or behavior in different ways.

Bi-directional semantic couplings are sensitive to context. Because the referent has a rich underlying data model (based on an ontology), a copy and paste operation into a constrained target context (such as a table) may result in more data appearing in the target than was present at the source—a surprising result, with the extra data coming from the data repository.

Similarly, context sensitivity and indirection allow information from multiple regions to be merged in a way that is semantically consistent and coherent (with reference to an ontology), and such that the structure and organization of the resulting new content reflects constraints imposed by the presentation (P).

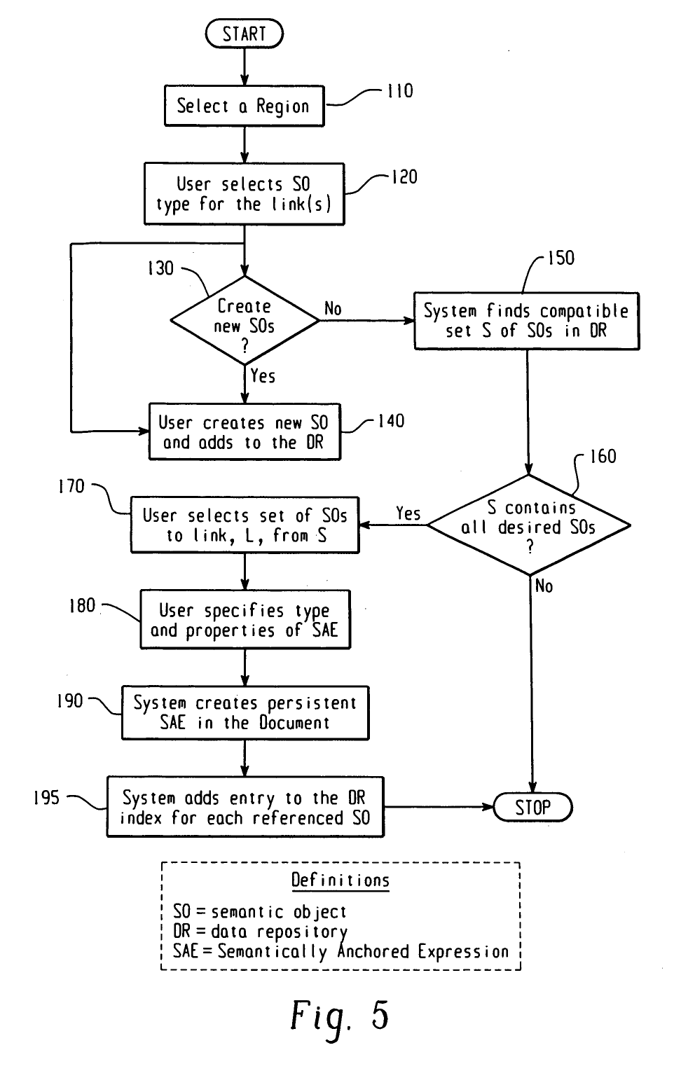

Turning now to FIG. 5, the basic process of creating semantically anchored expressions, i.e., the mechanism through which the user links a point or region within a document to one or more SOs in the data repository and further associates each referenced SO back to the point or region in the document, will now be explained. The steps of one embodiment are shown in FIG. 5, although several alternative implementations will also be discussed in this section.

The user selects at 110 a region having an IO in the document corresponding to the surface form of the desired SAE. This may be accomplished by highlighting or otherwise selecting a demarcated IO, or by simply placing the cursor or otherwise pointing to a point or location in the document (in the case of SAEs with null surface forms), and indicating by some means (e.g., context menu selection) the intent to create an SAE.

Alternatively, the system may nominate regions for SAEs using grammars, rules, patterns, among others, (generally referred to as Resources) and indicate the regions to the user through some form of user feedback (e.g., green squiggly lines under the surface expression of the IO). The operation would proceed upon indication or confirmation of intent to create an SAE.

Having selected a surface region for an SAE within the document, the user must then select at 120 the type of the semantic object(s) to which the SAE will point. If the SAE is to point to more than one SO, the SO types must be identical or at least compatible. An SO (SO1) is “type-compatible” with another SO (SO2) if (a) the constraints on the attributes of SO1 are completely encompassed by those of SO2, and one of (b) both SOs are of the same semantic type, or (c) SO1 is of a semantic type that is subsumed by that of SO2 in an Ontology or vice versa, or (d) b or c applies to SO1 and a component SO of SO2.

It is possible for the user to wish the target of the SAE to be an SO that does not currently exist in the data repository. For instance, the user may be a salesperson identifying a new customer unknown to the system. If the user has permission to add SOs to the data repository, the system prompts at 130 for this. The user creates the new SO at 140 and, if the user needs to create more than one new SO, a loop from 140 to 130 is traversed until all new SOs have been created.

If the data repository access model does not permit modifications, steps 130 and 140 may not be present in some implementations, in which case the system would proceed directly to 150 to query the data repository for existing matching SOs.

Also and independently, some implementations might select the SO type(s) after querying the data repository, in which case step 120 could follow 130 (or 150 if the data repository is read-only).

Given an SO type (or set of compatible types), the system nominates at 150 a candidate set of SOs from the data repository, and prompts the user to select one or more of the candidate SOs. This set may contain newly created SOs as well as existing data repository entries. In some implementations, if the user created new SOs, the set may be limited to those created in 140.

In the preferred implementation, the application would query the data repository once (perhaps upon initial connection) to determine possible SO types, organize the SOs for ease of display (e.g., into a hierarchical menu), and use Resources to examine the surface expression of the IO (if any), using that information to further narrow down the list of SO types. (For instance, if the user identified the text string “John Smith” as the surface expression of the SAE, and the system identified that string as a person name, the system might suggest the PersonName SO type.)

It is also possible for an implementation to additionally query the user for the SAE type and supplemental properties, then use that information to narrow the field of potential SOs. For instance, inserting a Value SAE that expresses the middle initial of a PersonName might cause the system to promote PersonName SOs with known middle initials over those with unknown middle initials.

After one of the foregoing scenarios is carried out, the system presents the user at 160 with a list of SOs. If the desired set of SOs is not in the repository, it is not possible to create the SAE, so the process stops. Otherwise, the user selects at 170 one or more SOs to associate with the SAE.

At this point, the user has identified the location (and optional surface expression) of the SAE, and the SOs to associate with it. Next, the user specifies at 180 the type and properties of the SAE. The type may be one of the set {Identity, Attribute, Value} or a user-defined functional type (with an arbitrary name). Depending on the logical requirements of the SO and SAE types, the user may also specify properties: a set of arbitrary attributes and values providing additional information required to express the SAE according to a P. For instance, an Attribute or Value type SAE might specify the name of the SO attribute to be expressed.

At this point, the system has all the information it needs to create at 190 the local portion of the SAE, a structured text specification (e.g., in XML) that is stored persistently with the document. This creates the coupling between the surface region and the SO in the data repository. However, the system must also associate at 195 each referenced SO in the data repository back to the surface region. That may be accomplished through a type of inverted index, which must minimally associate with each SO a list of pointers to SAEs within documents (e.g., through XPointer/XPath for XML documents), and the SAEs' type. This information enables efficient implementation of semantic operations such as Replace/Update and Merge.

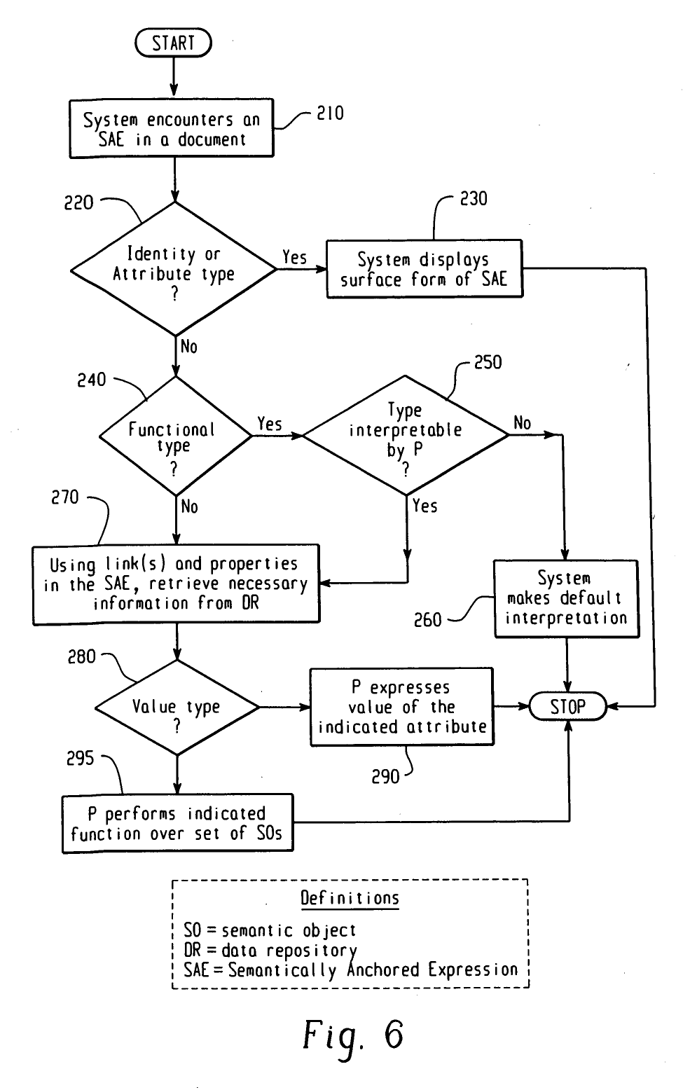

Turning now to FIG. 6, FIG. 6 describes the basic process of displaying or otherwise expressing semantically anchored expressions according to a P. The steps of a preferred embodiment are shown in FIG. 6, although alternative implementations will be apparent to practitioners of the art.

Through a given P, the system attempts to display or otherwise express at 210 an IO associated with an SAE. Note that this expression may be non-visual (i.e., behavioral) in some applications. For example, the system may respond with a beep or popup form whenever the user hovers over a region associated with a person SO.

The system next determines at 220 the type of the SAE. If the type is one of {Identity, Attribute}, the surface form of the SAE is displayed at 230. Otherwise, the SAE is either a Value or special Functional type, and the system requires information from the repository to express the SAE. If the SAE is a Functional type as determined at step 240 (i.e., has a name that does not match one of the set {Identity, Attribute, Value}), the system checks at 250 to see whether the P recognizes the type. If the function name is unrecognized by the current P, the system can only make a default interpretation at 260. This is implementation-dependent; options include displaying the surface form of the SAE, displaying an error message or placeholder, ignoring the SAE, etc.

If the SAE is a Value type or a Functional type, the system retrieves at 270 the indicated information from the SO(s) in the data repository. If it is a Value type as determined at 280, the value of the indicated SO attribute is expressed at 290. An example would be the LastName field of a PersonName SO. If it is a Function type, the system invokes the function on the P over the SO(s), using any supplied properties as arguments at 295.

Those of ordinary skill in the art will recognize that numerous alternative embodiments are possible such that there is no criticality to the ordering of most of the steps in FIGS. 5 and 6.

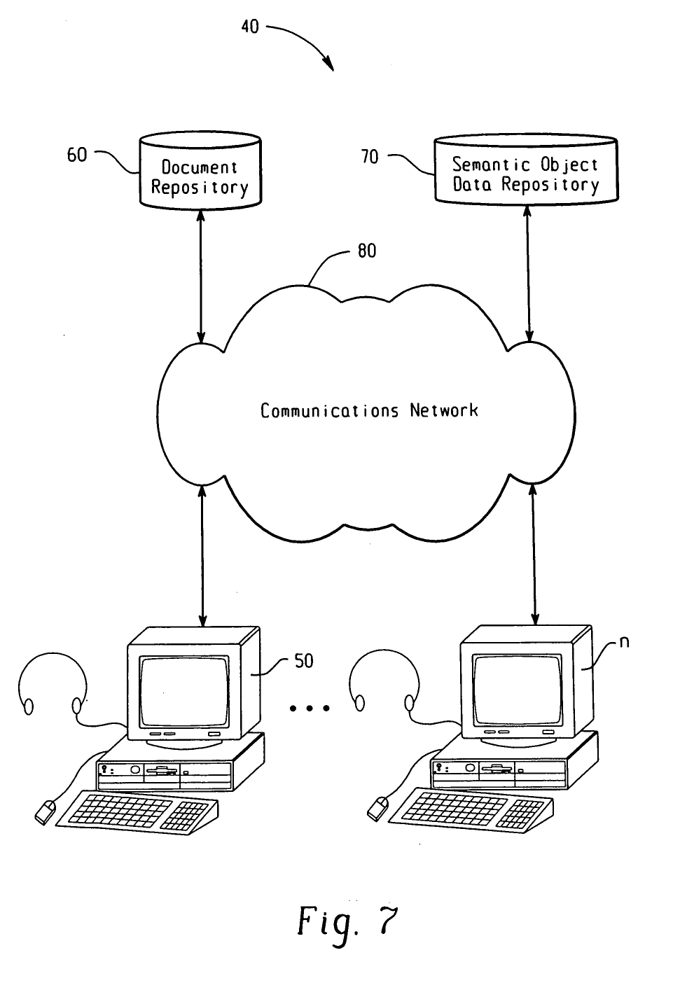

A system 40 is illustrated in FIG. 7 within which the methods disclosed herein may be practiced. The system 40 consists of local workstations 50 through n. The workstations 50, n communicate with a document repository 60 and a SO data repository 70 through a communication network 80. The document repository 60 may be any type of storage device for storing documents 10 of the type illustrated in FIG. 2. The data repository 70 is a mechanism that records and maintains information (whether structured or unstructured) related to or derived from the IOs that are processed by the system. The data repository 70 may be realized operationally as a number of different data-storage devices or structures. For example, the data repository 70 may encompass a discrete SO repository along with an inverted index that maintains such information as where references (associations) to specific SOs are located in various IOs in Documents. The SO repository may combine structured text storage (e.g., XML) with traditional relational tables. The network 80 may be any type of LAN, WAN, the Internet, etc. as circumstances dictate.

The terms “local” and “remote” may be defined with reference to FIG. 7. For example, workstations 50, n might be located in adjacent offices, and the document repository 60 and data repository 70 might be on the same floor. Alternatively, workstation 50 might be located in Pittsburgh, workstation n might be located in Philadelphia, with local document repositories resident on each of the workstations and a data repository 70 located in Toronto. Similarly, the software for creating the SAEs and displaying SAEs may be distributed within the system 40. Those of ordinary skill in the art will recognize that the configuration of any particular system 40 will depend in large measure on the current resources and assets of the particular enterprise in question.

Semantic Replace and Semantic Update

There are a variety of ways to change information in an existing semantic document, but they can be reduced to semantic replace and semantic update. The semantic replace operation consists of switching the link between an SAE and an SO to a different SO. The semantic update operation consists of changing the value of a particular attribute of an SO. Note that if the value is itself an SO, this may effectively result in a semantic replace operation. Let us consider the ways in which these two operations can be invoked.

Semantic replace may be invoked when the user selects an SAE and chooses to replace one of its SOs with another. This may or may not involve a change to the surface form of the SAE. For example, the “John Smith” mentioned in document A may not be the same “John Smith” mentioned in document B. In this case, the user may wish to replace SO[“John Smith”, 01] with SO[“John Smith”, 02] in document B. That change would not result in any changes to the surface expression of the SAE. Additionally, this change may need to be made just once, everywhere in document B, or in a variety of places throughout the document collection. Alternatively, the user could directly query to the SO repository and indicate the desire to replace one SO with another. In either case, the change may need to be propagated, based on user preferences or system defaults, to other SAEs linked to the same source SO in the replace operation.

Semantic update may be invoked when the user selects an SO and changes the value of an attribute. If the attribute has a simple type, it is only necessary to verify that all the SAEs with a value relation to that SO are consistent with the new value. If the attribute is itself a semantic object, the semantic replace operation is invoked on all SAEs with the appropriate attribute or value relation to that SO. A semantic update may also be invoked when the user changes the surface form of an SAE that has a value relation to an SO.

If an SAE has more than one SO and/or the replace operation is targeted for more than one SO, then a more complex semantic set replace operation (discussed below) is required.

For any change to a semantic document repository, the scope of the operation should be defined. A typical scope might be a single SAE only, all referentially identical SAEs in one document, or all referentially identical SAEs in the document repository. The scope may be determined manually, automatically, or in a semi-automatic manner. The scope might also be based on the type of the SAE. For example, if the user is updating the value of a particular attribute in an SO, one might typically expect that all SAEs of matching attribute or value type will automatically be within the scope. The user might also wish to look at SAEs with an identity type to make sure that the surrounding text is consistent with the updated SO. For example, consider a document containing a list of salespeople, including the SAE:[John Smith], linked with an identity relation to the SO:[John Smith]. If John Smith is promoted, and his job title attribute is changed to Sales Manager, then the user may wish to remove him from this list. Of course, a better way to solve this problem would be to build the list using a P that filters for people with the salesperson job title. In that case, the change would happen automatically at runtime. However, we cannot guarantee that all information objects in semantic documents are constructed in the best possible manner.

In a traditional text replace operation, scope is limited to a single document. Even in this case, the user may be required to examine and approve hundreds of individual changes. This problem is magnified in a semantic document repository, as a single semantic object may be linked to hundreds or thousands of SAEs across many documents. Therefore, it is likely that a fully functional semantic document processing system will have a sophisticated interactive scope selection environment that will enable the user to make high-level decisions about where to apply a change without having to view each SAE individually. This environment might summarize the linked SAEs for a given SO according to a variety of parameters, including: surface form, document type, document age, document directory, SAE type, or any number of customized parameters.

Furthermore, a fully functional semantic document processing system will have some mechanism for permissions and document access control. Most users will not have permission to modify every document in the repository. Therefore, it is important to introduce several additional concepts: semantic object versioning and delayed replacement.

Let us assume that the user wishes to replace person A with person B everywhere in the document repository because person A has left the company, but the user does not have permission to modify all the documents. In this case, instant replacement is limited to a subset of SAEs and the remaining SAEs are marked for delayed replacement. Delayed replacement means that the linking change is delayed until the next time a user with permission to change the document actually opens the document. The pending replace operation is cached somewhere in the system. Until the replace is completed (or rejected), other users may be given a cue that there is a pending replace for that particular information object. Delayed replacement could be applied to any document, not just to those with a read-only status for a given user.

In a semantic update operation, a similar problem with access control arises. This can be handled by semantic object versioning. Any change to a semantic object may (e.g., depending on user settings) result in a new version being created. Typically, an SAE will point to the latest version of a semantic object, but it might temporarily point to an older version until an authorized user approves the update operation. In some cases (e.g., historical published documents) the SAE may permanently point to an older version of the semantic object. Users can create a published version of any individual document at any time that simply freezes the version numbers of all links to semantic objects in the document.

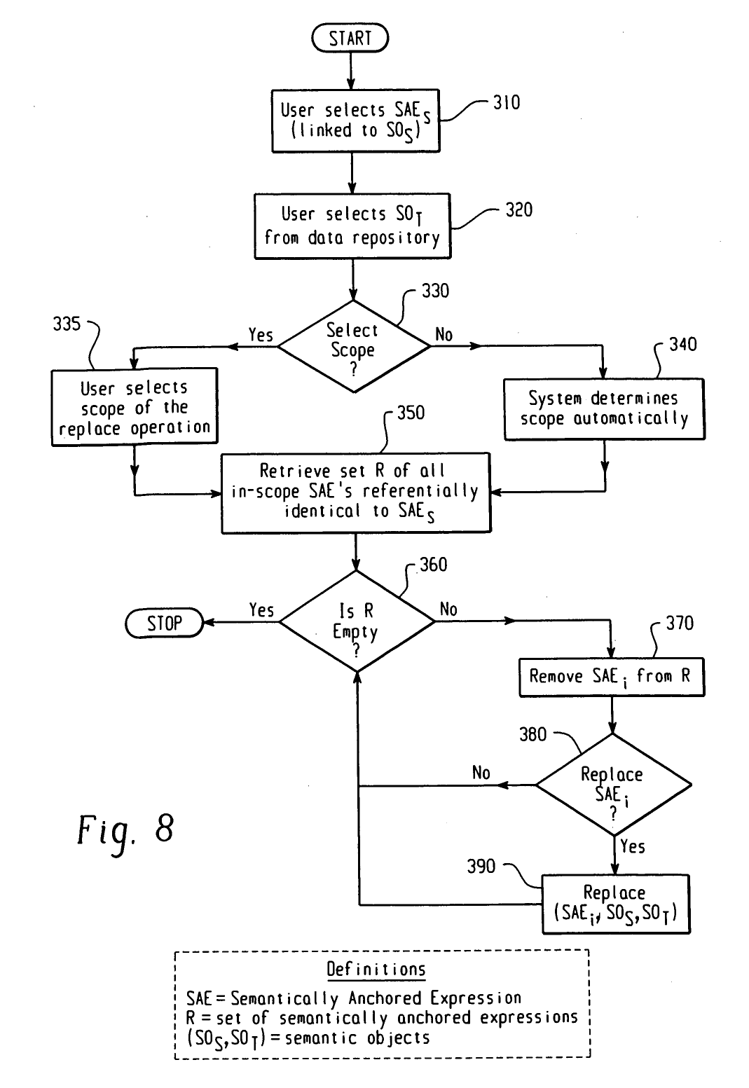

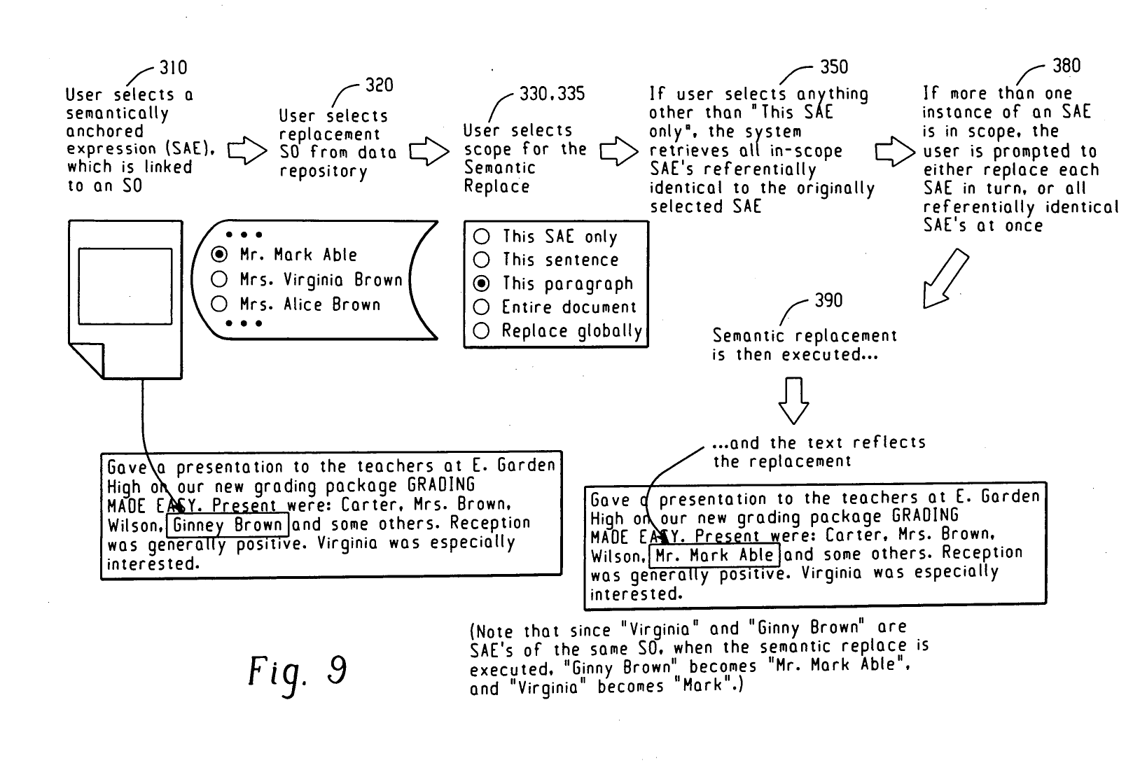

FIG. 8 is a flowchart illustrating one embodiment of a semantic replace operation according to the teachings of the present disclosure, although several alternative implementations will also be discussed in connection with FIG. 8. FIG. 9 is an example that schematically illustrates the embodiment of semantic replace according to the flowchart of FIG. 8.

The user selects at 310 an SAE in the document, with the SAE being linked to a first or source SO. The user selects at 320 a second or target SO from the data repository with the goal of replacing the source SO with the target SO according to some scope, which the user may be prompted at 330 to select. The scope is either selected by the user at 335 or determined automatically by the system at 340. Alternatively, the system starts with a default scope that is further refined by the user. Some common scopes include: this SAE only, all SAEs in this document, or all SAEs linked to this SO in the document repository. The scope defines a set R of SAEs eligible for replacement and is further filtered at 350 to include only those SAEs referentially identical to the selected SAE. SAE selection 310, target SO selection 320, and (optional) manual scope selection 335 may be performed in any order. If manual scope selection precedes SAE selection, then SAE selection may not be necessary. SAE selection 310 may be accomplished by choosing the SAE directly or by selecting a region of the document, seeing the SAEs overlapping with that region, and then picking one of those SAEs. The target SO 320 may come from the data repository or it may be created on-the-fly by the user.

At this point, we have a source SO, a target SO, and a set R of SAEs pointing to the source SO. We now iterate at 360, 370 through the set R of SAEs and execute a replace operation 390 which replaces target SO for the source SO for the SAE in issue. The user may be asked to accept or reject each replacement at 380 or this decision may be made automatically by the system. Furthermore, the decision may be manual for some SAEs and automatic for other SAEs based on some features of each individual SAE.

While steps 360, 370 demonstrate an iteration mechanism that removes elements from the set, any iteration mechanism that returns each element of the set exactly once can be used in this phase. The actual replace operation may be executed immediately as it is approved or the intention to replace may be cached and the actual execution may occur in one or more batches either during or after iteration is completed. The replace operation on the initial SAE may be executed immediately (e.g., any time after 310 and 320 but before 360) or the selected SAE may be included in the set R and replaced during the normal iteration sequence. Steps 360, 370 demonstrate an iteration mechanism over individual SAEs. Iteration may also be implemented over one or more groups of SAEs. In this case, the decision to replace 380 may be made either manually or automatically for the group as a whole. For example, the SAEs may be grouped by surface form. The replace function 390 has three arguments: an SAE, a source SO, and a target SO. The replace function changes the SAE link from the source SO to the target SO and updates the SO/SAE association table.

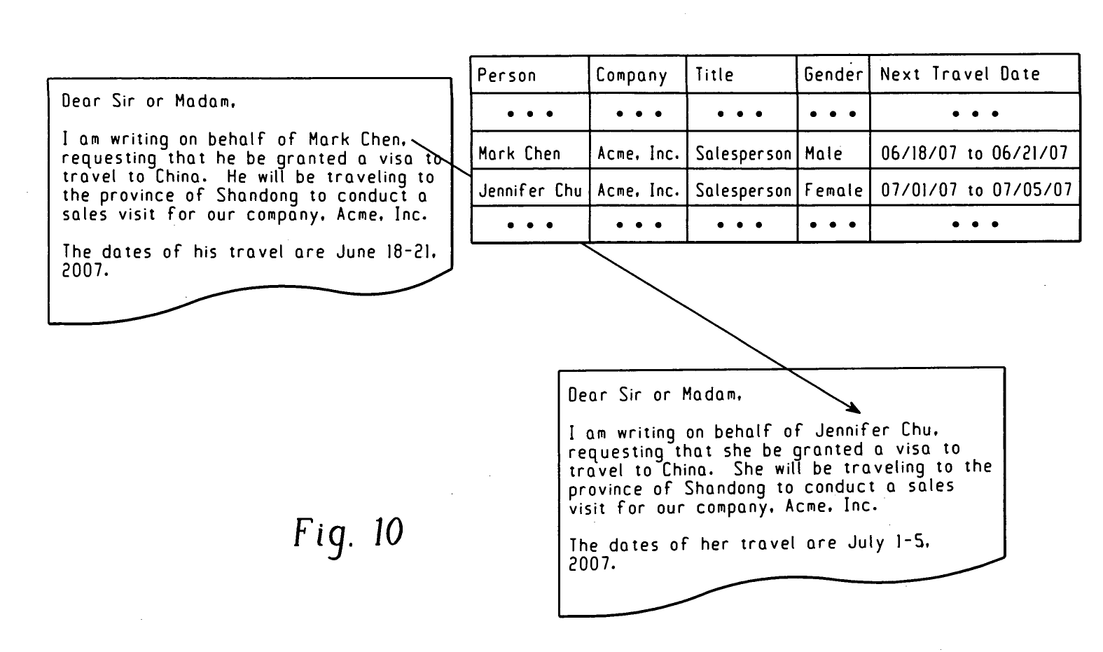

FIG. 10 is another example of semantic replace. In this example, “Mark Chen” has been replaced with “Jennifer Chu.” Because the user replaced a semantic object and the gender is different, all SAE's linked to that semantic object that are no longer consistent will change accordingly. The change is made based on the gender attribute of the entity in the semantic object repository.

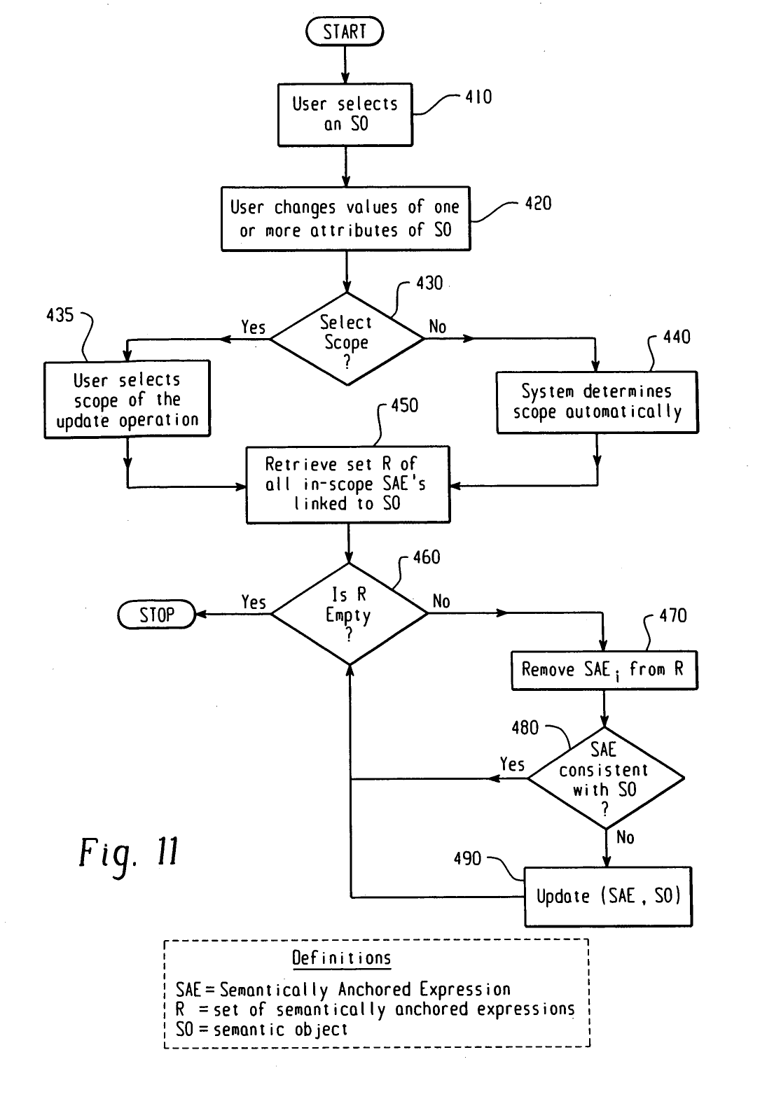

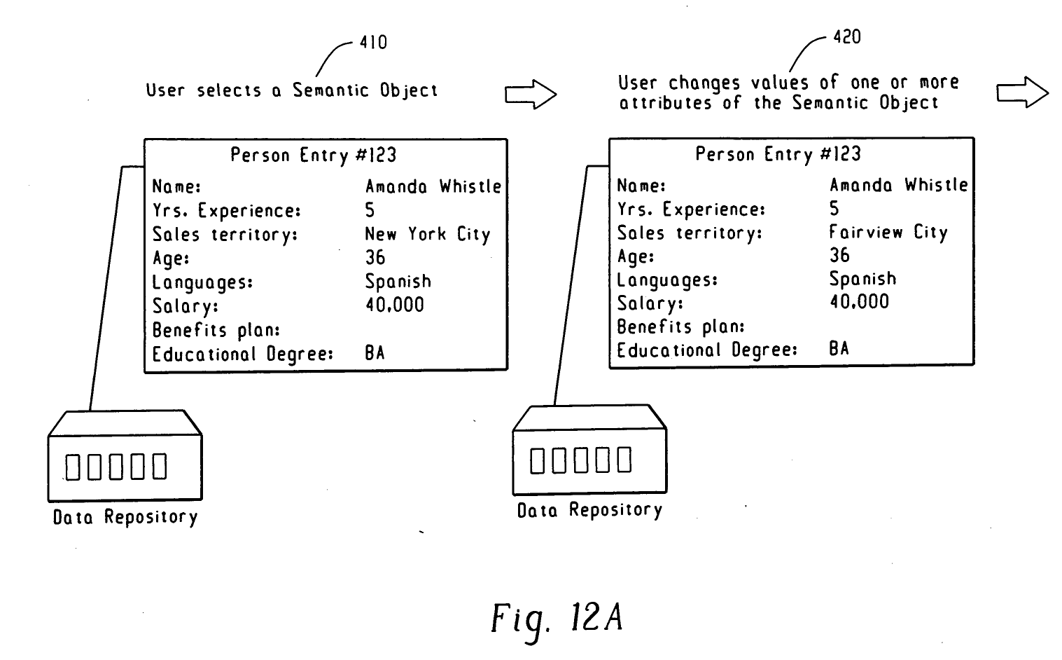

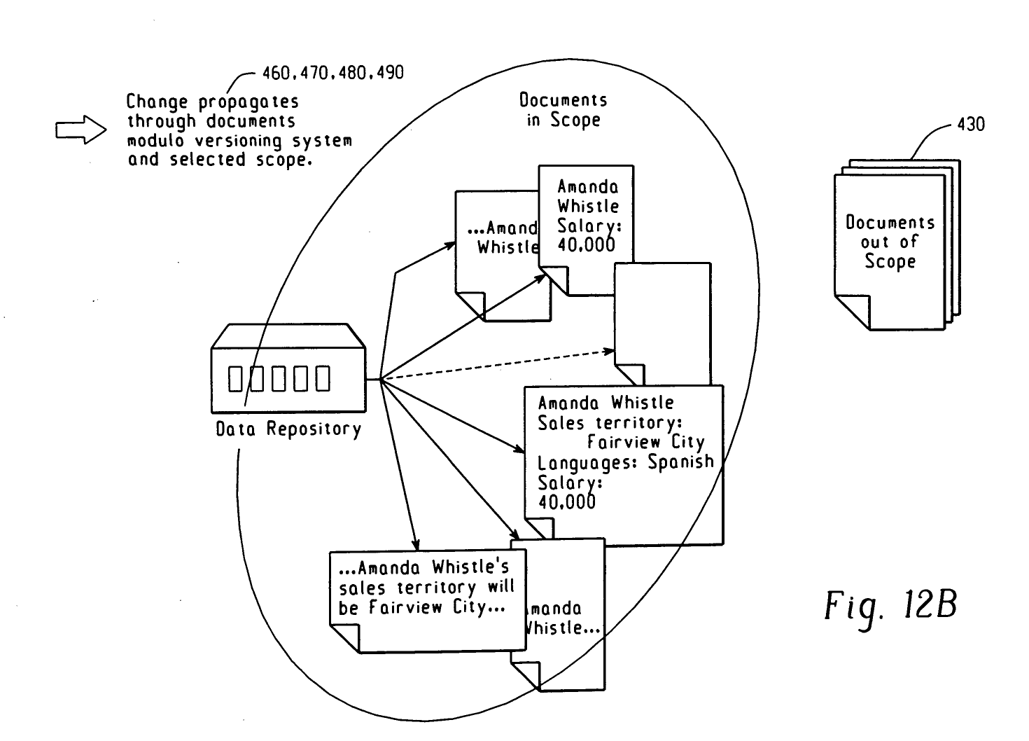

FIG. 11 is a flowchart illustrating one embodiment of a semantic update operation according to the teachings of the present disclosure. FIGS. 12A and 12B are an example that schematically illustrates the embodiment of semantic update according to the flowchart of FIG. 11.

The user begins by selecting at 410 an SO. At 420 the user changes the SO, typically by changing the values of one or more the attributes of that SO or by adding new attributes. The user is prompted at 430 to select a scope. At 435 the user may manually select a scope or the scope may be automatically selected by the system at 440. Alternatively, the system starts with a default scope that is further refined by the user. The scope defines a set R of SAEs linked to the SO that are eligible for update and will typically include those SAEs that have an attribute or value relation with at least one of the changed attributes in the SO. Steps 410, 420, 430, 435, 440 can be completed in many different orders. For example, attribute selection 420 may follow scope selection 430, 435, 440. Scope selection may include SO selection, in which case 410 is no longer required.

At this point, we have an updated SO and a set R of SAE's linked to that SO. We now iterate 460, 470 through the set R of SAEs. At 480 a determination is made whether the SAE is consistent with the updated SO, and, if the SAE is no longer consistent, an update function 490 is executed to update the SAE and make it consistent with the changed SO. An SAE in a value relation with the SO is not consistent if the surface form does not satisfy the constraints of the attribute. The constraints may take a number of forms, such as, but not limited to: exact match to a string value, membership in a set, or numeric value in a certain range. Consistency testing and updating may be automatic in some cases and manual in other cases, depending on the nature of the attributes and its constraints, or user preference. The update function 490 changes the surface form of the SAE in such a way that it satisfies the attribute constraints of the linked SO.

Replace/update operations are potentially recursive, and the surface form reconciliation process must take into account a wide range of possible data types within complex SO structures, as well as display and behavioral constraints specific to presentations. It is therefore conceivable that an SO might be updated in such a way as to preclude consistency with one or more SAEs. In this special case, the system might disable the link with notification, perhaps prompting the user to delete it. One possible implementation would define a common function type for “invalid” or “expired” SAEs, and change the SAE type to this value. Presentations could then interpret these SAEs in specific ways; e.g., ignore them, highlight them, etc. Changing the SAE type locally in the document also implies an update of the data repository (which stores the SAE types in its inverted index). This in turn has implications for various semantic operations (e.g., for propagation of replace/update operations; the system would likely not follow “expired” links).

While steps 460, 470 demonstrate an iteration mechanism that removes elements from the set, any iteration mechanism that returns each element of the set exactly once can be used in this phase. The actual update operation may be executed immediately or the intention to update may be cached and the actual execution may occur in one or more batches either during or after iteration is completed. Steps 460, 470 demonstrate an iteration mechanism over individual SAEs. Iteration may also be implemented over one or more groups of SAEs.

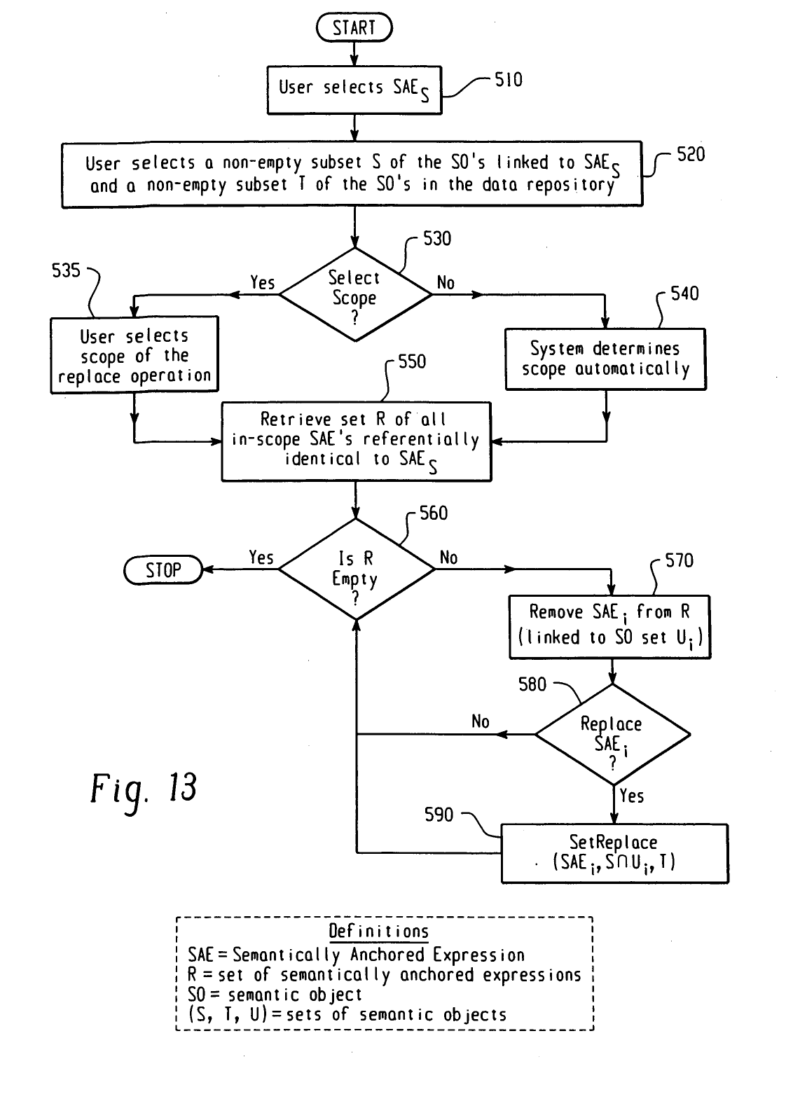

FIG. 13 is a flowchart which illustrates a more general version of semantic replace that supports the replacement of multiple source and target semantic objects. In the discussions of semantic replace so far, it has been assumed that the SAE was linked to exactly one source SO that was being replaced by exactly one target SO. In semantic set replace, the SAE may be linked to more than one SO, or the replacement target may be more than one SO, or both conditions may hold. The user selects at 510 an SAE in the document, and then chooses at 520 a non-empty subset S of source SOs linked to the SAE and a non-empty subset T of target SOs. In this operation, it is assumed that the cardinality of at least one of these sets (if not both) is greater than one to differentiate from the basic semantic replace operation.

In response to a prompt at 530 to select a scope, the scope of the operation is either selected at 535 by the user or determined automatically at 540 by the system. Alternatively, the system starts with a default scope that is further refined by the user. The scope defines a set R of SAEs eligible for replacement and is further filtered at 550 to include only those SAEs referentially similar to the initial SAE. Source SAE selection 510, target SO selection (second part of 520), and (optional) manual scope selection 535 may be performed in any order. If manual scope selection precedes SAE selection, then SAE selection may not be necessary. SAE selection 510 may be accomplished by choosing the SAE directly or by selecting a region of the document, seeing the SAEs overlapping with that region, and then picking one of those SAEs. The target set T of SOs 520 may come entirely from the data repository or one or more may be created on-the-fly by the user.

At this point, we have a set S of source SOs, a set T of target SOs, and a set R of SAEs pointing to at least one of the source SOs. We now iterate 560, 570 through the set R of SAEs and execute a set replace operation 590 which takes the SAE, the set T, and elements of set S linked to the SAE. The user may be asked at 580 to accept or reject each replacement or this decision may be made automatically by the system. Furthermore, the decision may be manual for some SAEs and automatic for other SAEs based on some features of each individual SAE.

While steps 560, 570 demonstrate an iteration mechanism that removes elements from the set, any iteration mechanism that returns each element of the set exactly once can be used in this phase. The actual set replace operation may be executed immediately as it is approved or the intention to replace may be cached and the actual execution may occur in one or more batches either during or after iteration is completed. The set replace operation on the initial SAE may be executed immediately (e.g., any time after 510 and 520 but before 560) or the initial SAE may be included in the set R and replaced during the normal iteration sequence. Steps 560, 570 demonstrate an iteration mechanism over individual SAEs. Iteration may also be implemented over one or more groups of SAEs. In this case, the decision 580 to replace may be made either manually or automatically for the group as a whole. For example, the SAEs may be grouped by surface form. The set replace function 590 has three arguments: an SAE, a set of source SOs, and a set of target SOs. The set replace function removes links to the source SOs and adds links to the target SOs.

Semantic Copy and Paste and Semantic Cut and Paste

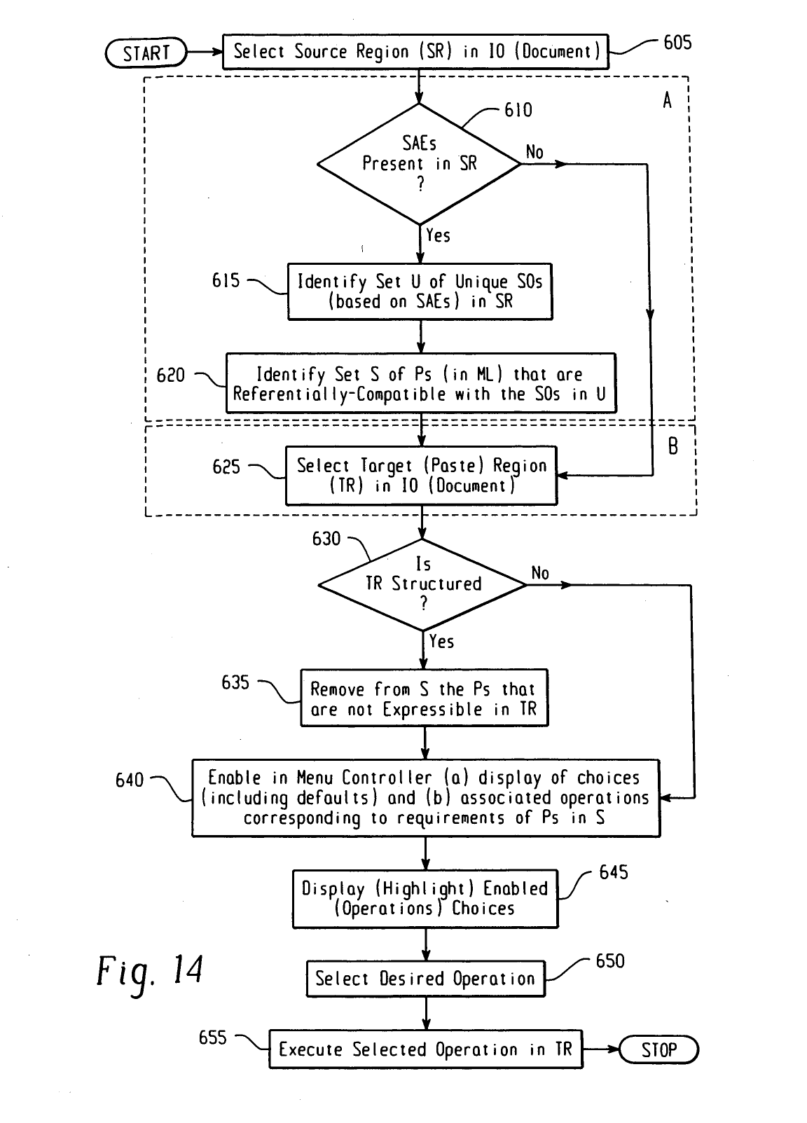

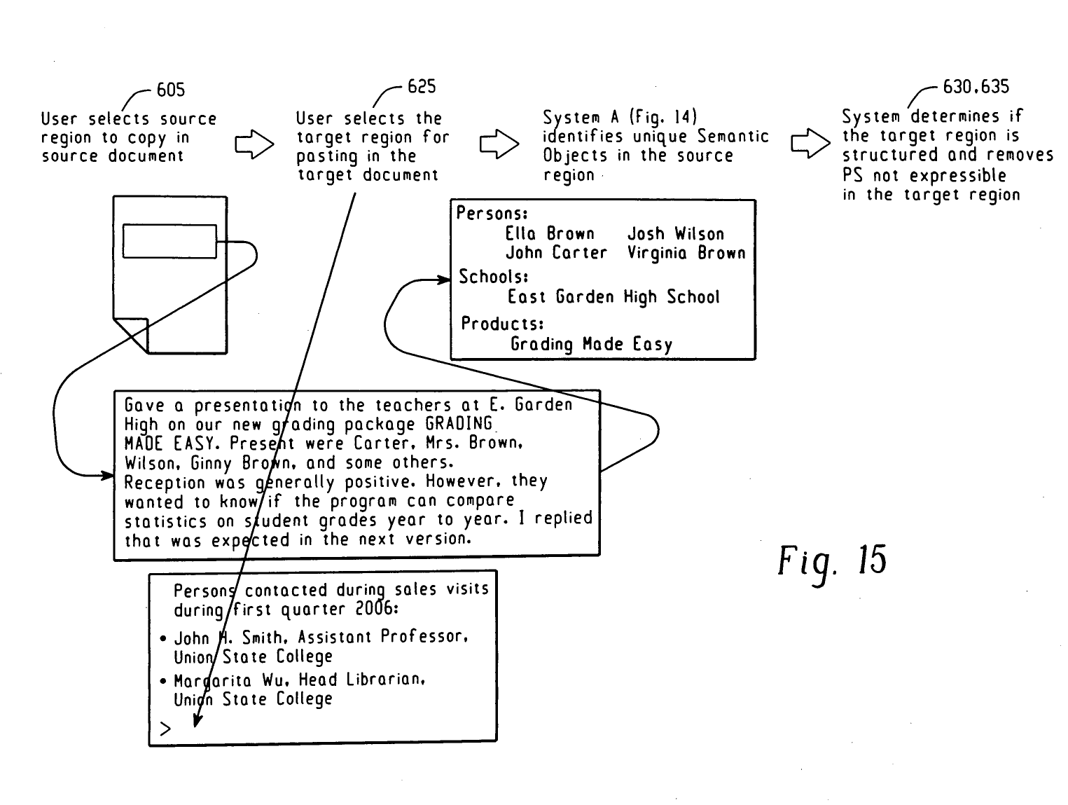

Turning now to FIG. 14, the steps of a preferred implementation of a semantic copy and paste operation are shown. The user selects at 605 a Source Region (SR) in the IO, for example, a document. Selection may be either manual or via some automated process. The system determines at decision step 610 whether SAEs are present in the SR and, if so, identifies at 615 a unique set, U, of SOs that the SAEs are linked to. This identifying may be performed based on existing mark-up or, alternatively, a process may be run using Resources. As a practical matter, this may involve the look-up of SAEs in a table (index) or the sorting of the link references on the SAEs in the SR.

The system then identifies at 620 a set, S, of Ps in a Menu Library ML that are referentially compatible with the SOs in the set U. This involves identifying the unique set of types of properties of the SOs in the set U and comparing these with the required and optional types for each of the Ps in the ML.

A Menu (M) is a display that lists the actions that may be performed by the system given (a) the contents of a buffer (possibly null), (b) a location in the local document(e.g., point in a document or data structure), and (c) a set of operations the system can perform. Menus may be designed to be “fixed” in their location (e.g., as in an item in a menu bar) or dynamic (as in a “pop-up” presentation). A menu may include auditory presentations. The Menu can be invoked in a variety of ways (well represented in contemporary systems). As a practical matter, the Menu will list the types of “paste” actions that a user can request the system to perform.

The Menu Library (ML) is a set of Ps reflecting the structure and display characteristics of the data on which Menu actions can be performed. An example of a P in the ML might be the specifications for the presentation of a list of specific types of items; or a list that displays a specific set of Properties of SOs; or a table with rows and columns filled in with particular types of information; or a graph of a particular type (e.g., pie chart) where the input values derive from a function on Properties of SOs of particular types; etc.

A P is “referentially-compatible” to one or more SOs if and only if (a) all the required, (b) any optional, and (c) none of the prohibited attribute/value/property types of the P are present in at least one of the SOs

Returning to FIG. 14, if there are no SAEs in the SR as determined in step 610, then the system does not attempt to select Ps from ML. The user then selects at 625 a Target Region (TR) into which the copied material will be pasted. Again, the selection can be either manual or through some automated process. Note that the TR may be a point in an IO or may be a span of an IO or may be an existing structured object. The system determines at 630 whether the TR is a structured object and, if so, removes at 635 from the set S any P that is not expressible in the structured object. If the TR is not structured, there is no need to modify the set S.

At this point, the system is prepared to enable the choices in the menu along with the associated required actions for the Ps in the set S as shown at 640. In the menu, the choices corresponding to the Ps may be organized, e.g., hierarchically in cascading sub-menus, for more efficient display. Note that the set S may be empty in step 640 as a result of incompatibility of the Ps in the set S with the TR and the filtering of the set S in step 635. The set S may also be empty because there were no SAEs in the SR as determined in step 610. In the event that the set S is empty, the system indicates that no semantic copy operation is possible. However, the system may be configured to perform one or more default non-semantic copy operations, provided they are compatible with the TR. Based on the available operations, including defaults, choices are displayed at 645 in the menu.

There are a variety of techniques in common practice for making the menu available to the user, including having the user navigate to a fixed location in a menu tab or having the user invoke a pop-up display of the menu through an action such as depressing a mouse button. The disclosed method does not depend on any particular method. When the user indicates at 655 which operation to perform, the system executes the operation in the TR at step 155. Execution involves a process in which the required attributes/values/properties for display (insertion) are retrieved from the SOs and presented in the format specified by the P (possibly determined, in part, by the P or Ps or other features/constraints in the context that scope over the selected TR).

Note that the steps 610, 615, and 620 (designated “A” in FIG. 14) could be performed after step 625 (designated “B” in FIG. 14) without loss of functionality. The selection of an SR provides the system with information about the contents that will be subject to a paste operation and the selection of a TR provides the system with information about the location where the paste operation is to be performed and the constraints, if any, on the operation. The SOs in the SR can be discovered and the characteristics of the TR can be determined after both regions have been selected.

The steps for semantic copy and paste as described above can also provide the functionality required for semantic cut and paste. The difference is that, upon execution of the paste operation, the system deletes from the IO the contents of the SR.

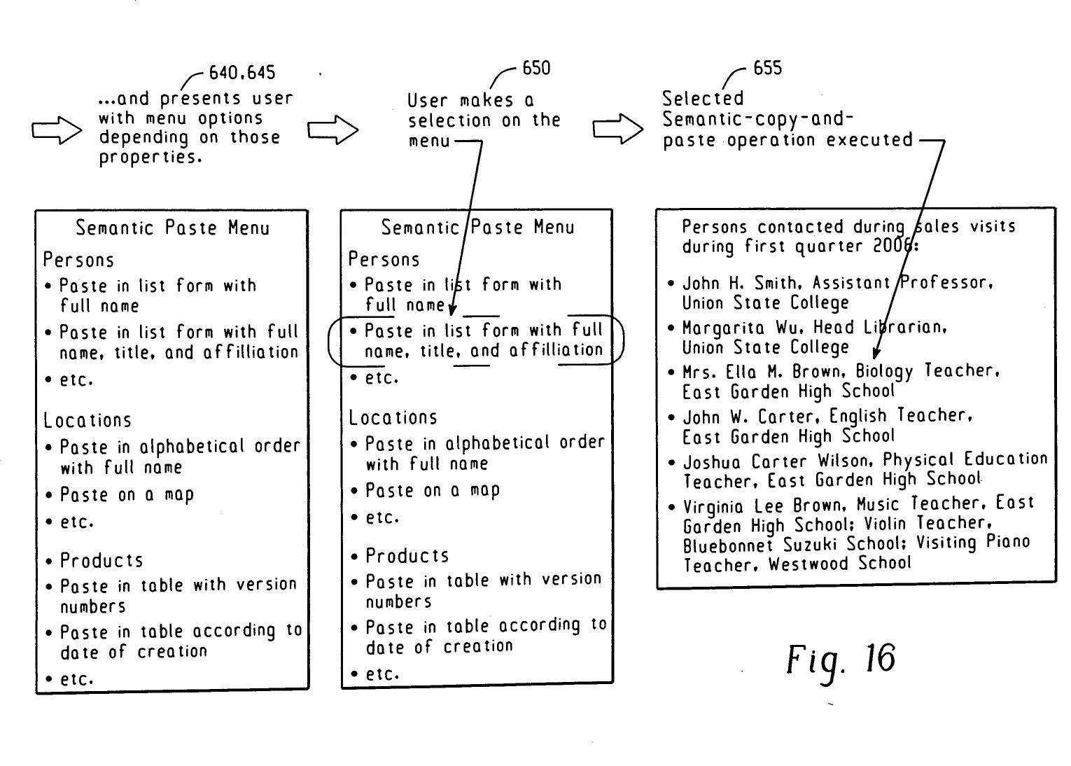

The process illustrated in the flowchart of FIG. 14 is illustrated schematically in FIGS. 15 and 16. The process shown in FIGS. 15 and 16 is the embodiment where B in FIG. 14 is performed before A. FIGS. 15 and 16 illustrate examples of what the source region, target region, semantic paste menu and completed document after the semantic copy and paste operation are completed might look like.

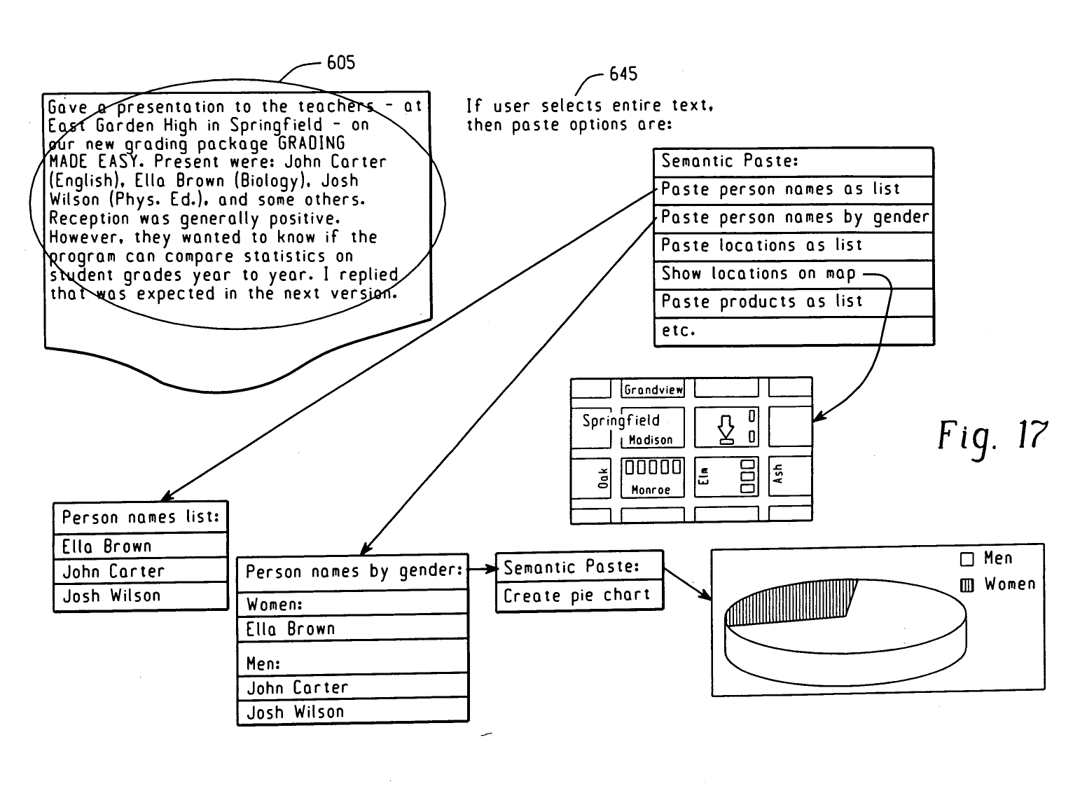

FIG. 17 is a simplified view of the process shown in the flowchart of FIG. 14 with examples of what the various options in the menu might look like.

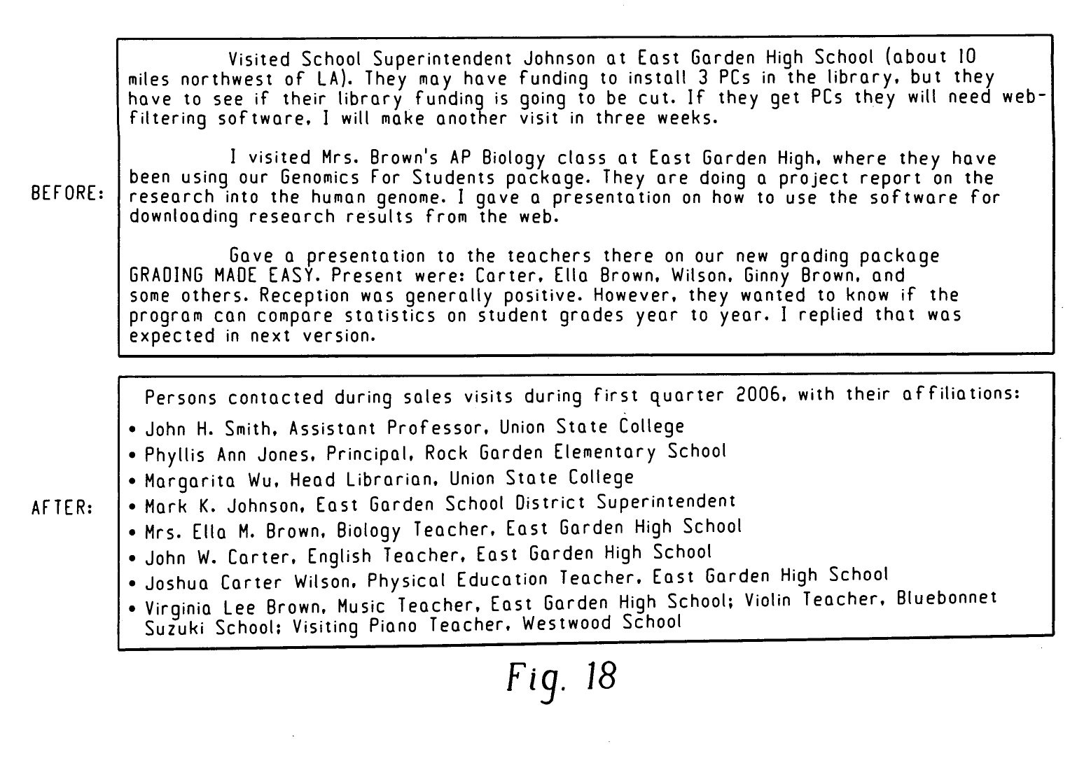

FIG. 18 illustrates the effect of a semantic copy and paste operation in which copied material expresses previously unavailable information when pasted into a target region. The “before” representation represents the user's selection of the SR in the IO (step 605 in FIG. 14). The “after” representation represents what the TR looks like after the semantic copy and past operation is completed. Note the disambiguation, uniquely identified persons, and “discovery” of new information. Even with a detailed understanding of the semantic underpinnings, the “after” presentation is clearly a surprising result.

Semantically informed text operations require maintenance of the links between surface regions and semantic objects, both in the local documents where the surface regions appear and in the remote semantic object repository. Paste operations generally require the creation of new semantically anchored expressions in the target region; the system would copy the type, properties, and link(s) to form the new SAEs, while altering their surface region specifications to match the target location. At runtime, the system would interpret the SAEs in the new location such that their surface expressions would usually match that of the source, though in general the surface expression of copied SAEs might be different due to local presentation constraints (e.g., copying data from a free text region into a structured table). Cut operations generally require the deletion of content from the source region, including SAEs with surface regions that fall within its boundaries. (SAEs that are discontinuous or otherwise have only partial extension within the source region are special cases that must be handled separately, perhaps by truncating their associated surface regions.) Thus, those of ordinary skill in the art will recognize such “housekeeping” matters are necessary for the system to keep track of the location and changes in location of the surface form of the SAE. Such matters are well within the skill of those of ordinary skill in the art and therefore need not be further discussed.

Semantic Merge

An advantage of a merge operation informed with semantic information is that, when the user chooses multiple sources to merge, the document management system will try to identify the semantic relevance of the sources and merge together those parts of the sources that are semantically the most relevant. The merge result will also be formatted with respect to the constraints of the target region. Such an operation is more refined and results in merged content that is semantically more coherent than that derived from simple appending, and avoids manual adjustment by the user.

Semantic merge is invoked when the user selects a number of source regions (which can be whole documents) and a target region. The system will first identify SOs in the target region that other SOs can be merged into, and then iterate through each such SO to retrieve type-compatible SOs in the source regions and position them at the right locations in the target SO. Finally the target region SOs will be formatted and displayed under the constraints of the target region. The source regions can be of three types as listed in the table below, or any combinations of them. The target region can also be any of the three types or combinations of them.

TABLE 1
Merge different types of document regions

| | Free Text | | Semi-Structured |
|---|---|---|---|
| Document | encompassing | Complex Semantic | Complex Semantic |
| Regions | Primitive SOs | Object (CSO) | Object (SCSO) |
| Free Text | ✓ | ✓ | ✓ |
| CSO | x | ✓ | ✓ |
| SCSO | x | ✓ | ✓ |

In general, a complex SO cannot be merged into a primitive one, and merging different types of regions is subject to the constraints in the target region.

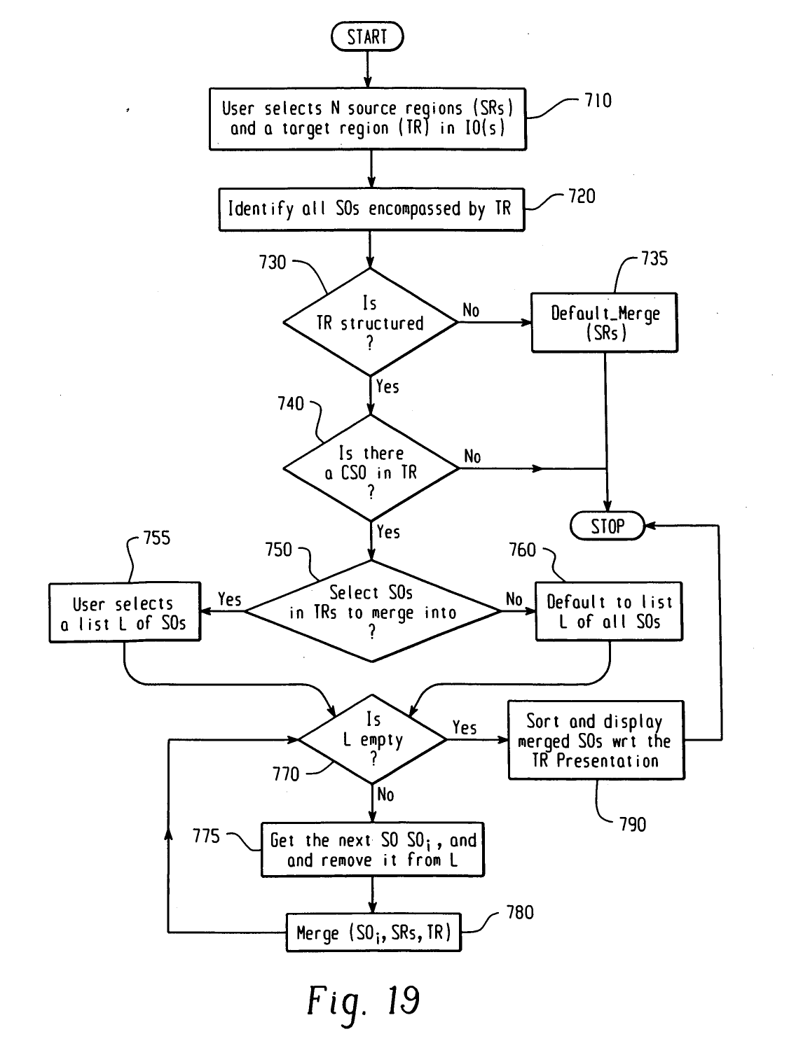

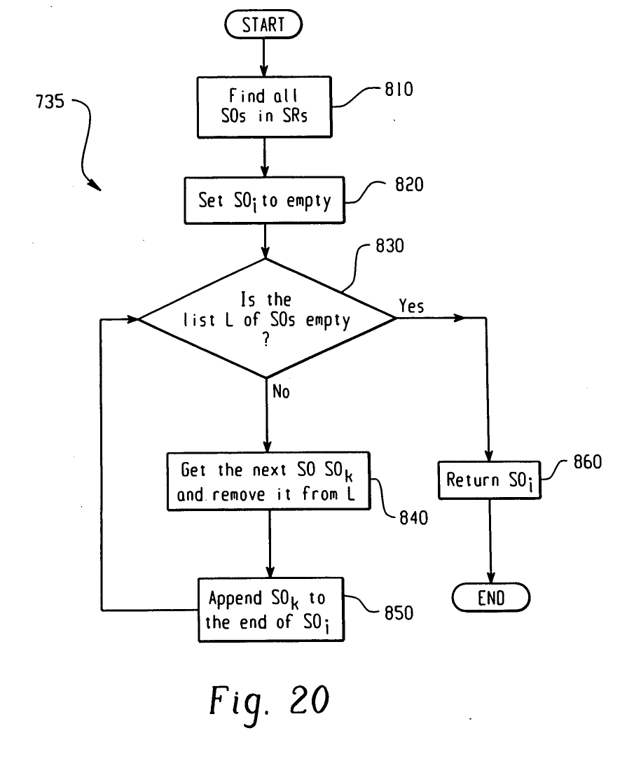

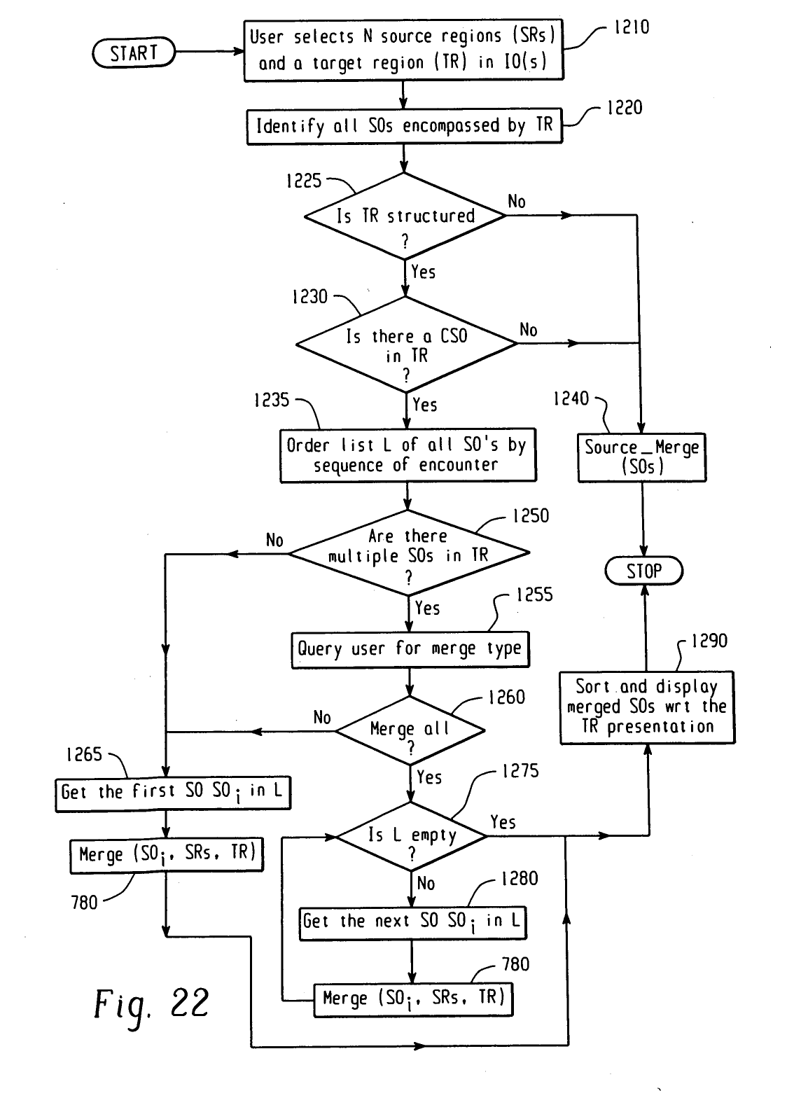

FIGS. 19 and 22 are flowcharts describing two basic semantic merge operations according to the present disclosure. The embodiment shown in FIG. 19 is more restrictive and does not give the user as many choices as the embodiment in FIG. 22. In FIG. 19, the user selects at 710 a number of Source Regions (SRs) and a Target Region (TR) in an information object or document with the goal of merging the content of the SRs and putting the results in the TR. The target region can either be one of the source regions, or be a separate region from the selected source regions. The system will automatically identify at 720 all the semantic objects (SOs) encompassed by the target region. If there is no SO in the target region, the region will be of minimum structure or unstructured as determined at 730. In this case, a default merge process 735 will be executed, as described below in conjunction with FIG. 20.

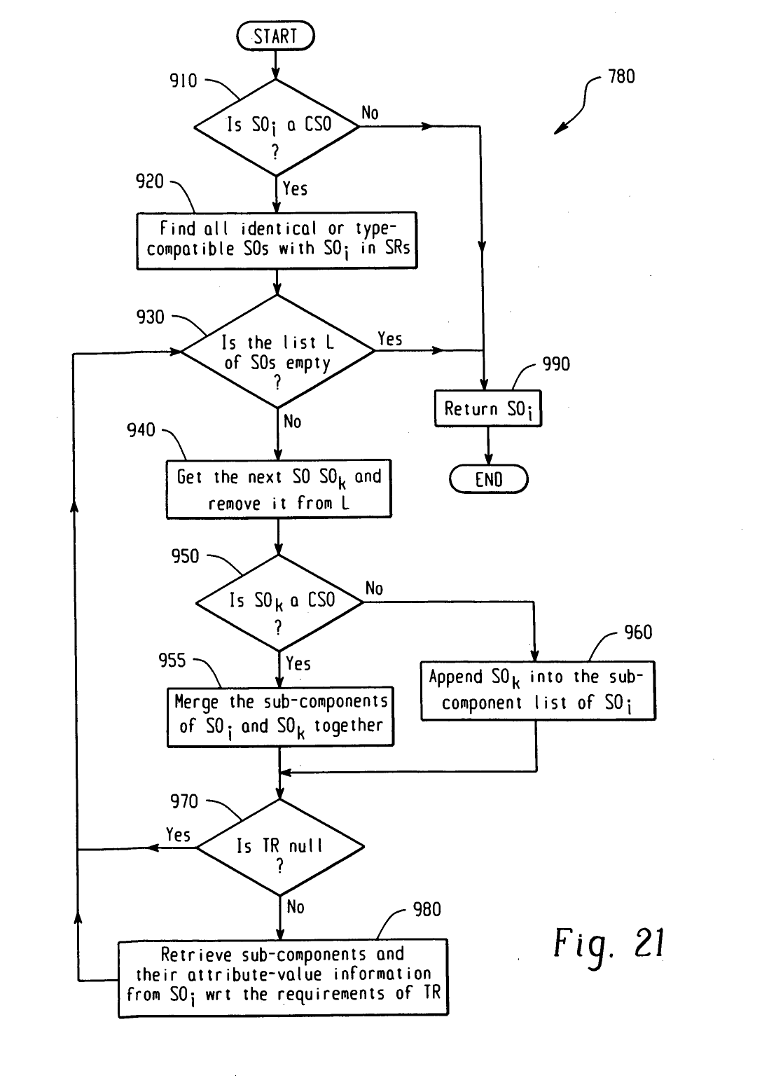

If on the other hand the target region contains at least one SO, the system will then check at 740 to determine if the target region contains a Complex SO (CSO). If not, that means that only primitive SOs are present and primitive SOs do not allow other SOs to be merged into them. In that case, the semantic merge process will end and a default process may be applied, such as a simple append of the SR to the TR such as is discussed below. When there is at least one Complex SOs in the target region, the system will determine at 750 which SOs to merge. The user may select at 755 a list of SOs, or a default strategy will create at 760 a list of all SOs in the target region. The system then iterates through the list of SOs, retrieving at 775 the next SO from the list and performing a merge operation at 780 on the retrieved SO as described below in conjunction with FIG. 21, until the list is empty as determined at decision step 770. Finally, the system formats the merged SOs with respect to the presentation specifications of the target region, and presents the merged document to the user at 790.

Turning to FIG. 20, the steps of the default merge process 735 are shown. This process creates at 810 a list of all SOs in the source regions. It then iterates through the list, retrieving at 840 the next SO from the list, and appending the retrieved SO at the end of the previous SO at 850, until the list is empty as determined at 830. Finally it returns at 860 the SO that contains all appended SOs in the source regions.

Turning to FIG. 21, the steps of the merge process 780 of FIG. 19 are shown. This is a general sub-process that is called upon by other processes to perform the actual merge. This process takes a target SO, a number of source regions, and a target region as parameters, and tries to merge compatible SOs in the source regions into the target SO. The system first checks at 910 if the target SO is a Complex SO. If not, it will return at 990 the target SO without merging anything into it. If yes, the system finds at 920 a list of all identical or type-compatible SOs from the source regions. If the list is empty as determined at decision step 930, the system returns at 990 the target SO, again without merging. Otherwise, it iterates through the list, retrieves at 940 the next SO from the list, and checks at 950 if this is a Complex SO. Depending on the type of the SO, the system will either merge at 955 the sub-components of the two Complex SOs, or append at 960 this SO into the sub-components of the target SO. An optional step, step 970, determines if the TR is null. The above steps iterate until the list is empty.

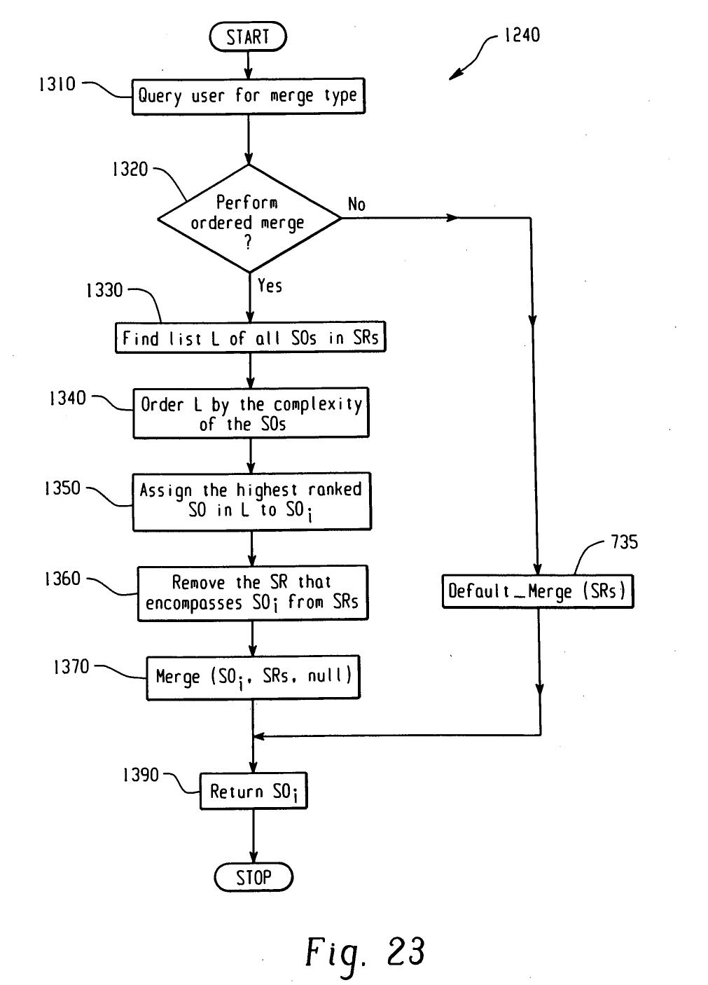

The steps of a second embodiment are shown in FIG. 22. Similar to the first embodiment, the user selects at 1210 a number of source regions and a target region, and the system will identify at 1220 all SOs encompassed by the target region. If the system at 1225 finds no SO in the region or finds at 1230 no Complex SO in the region, the system will execute a source merge process 1240 (described below in conjunction with FIG. 23), rather than the default merge process 735 as in the first embodiment.

If there is at least one Complex SO in the target region, the system will order the list of all SOs in order of their occurrence at 1235. When there is only one SO in the list, the system retrieves at 1265 the first SO and executes the merge operation 780 (see FIG. 21) on it. When there is more than one SO in the list, the system will query the user at 1255 for the type of merge to perform. The user can choose among Merge First, which is the same as the previously described merge, Merge Select, which is the same as that described in the first implementation, and Merge All. For this third choice, the system will iterate beginning at 1275 through the list of SOs, retrieve at 1280 the next SO from the list and perform the merge operation 780, until the list is empty as determined at 1275. Finally, the system formats the merged SOs with respect to the presentation specifications of the target region, and presents at 1290 the merged document to the user.

Turning to FIG. 23, the steps of source merge process 1240 are shown. This process queries the user at 1310 for the type of semantic merge to perform. The user can choose between the default merge process 735 (See FIG. 20), or an ordered merge at step 1320. For this second choice, the system will find at 1330 the list of all SOs in the source regions, and order at 1340 the list of SOs by their complexity. That is, a Complex SO will be ranked higher than a Semi-structured Complex SO, which in turn is ranked higher than a primitive SO. When two SOs are of the same complexity, ties may be broken by any of a number of methods, such as by the size of the surface regions that are associated with the SOs. The system then treats the highest ranked SO as the target SO at step 1350, removes at 1360 this SO and its associated source region from the lists, and executes at 1370 the merge operation on this SO. Finally the process will return the merged SO at step 1390.

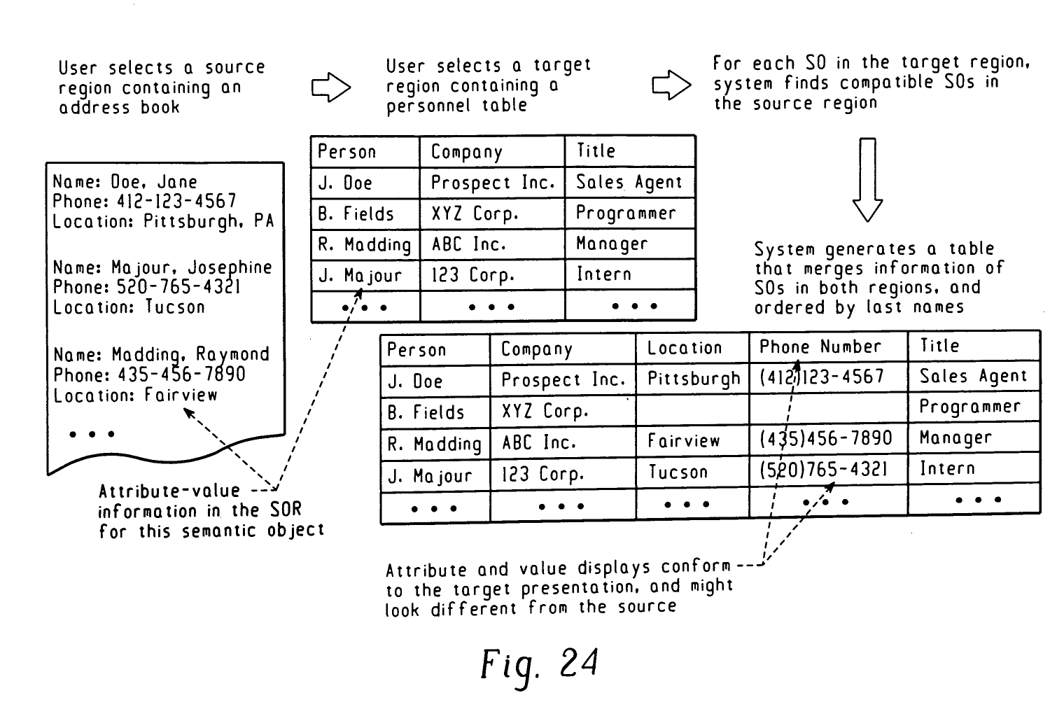

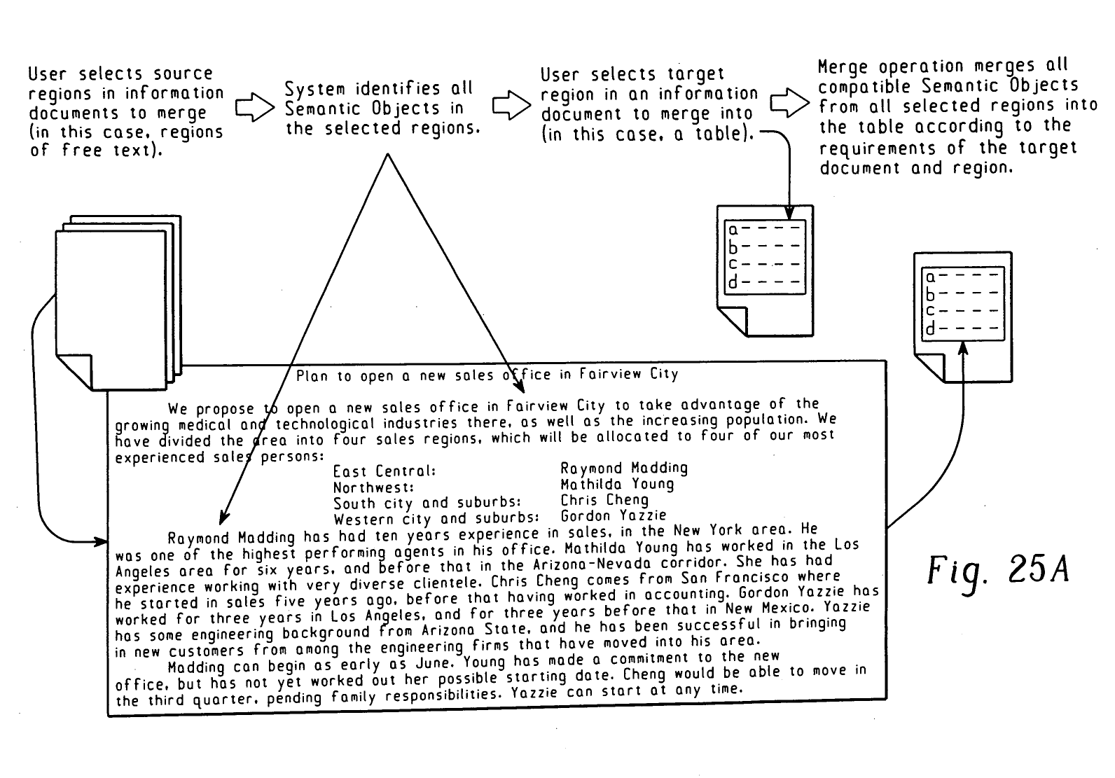

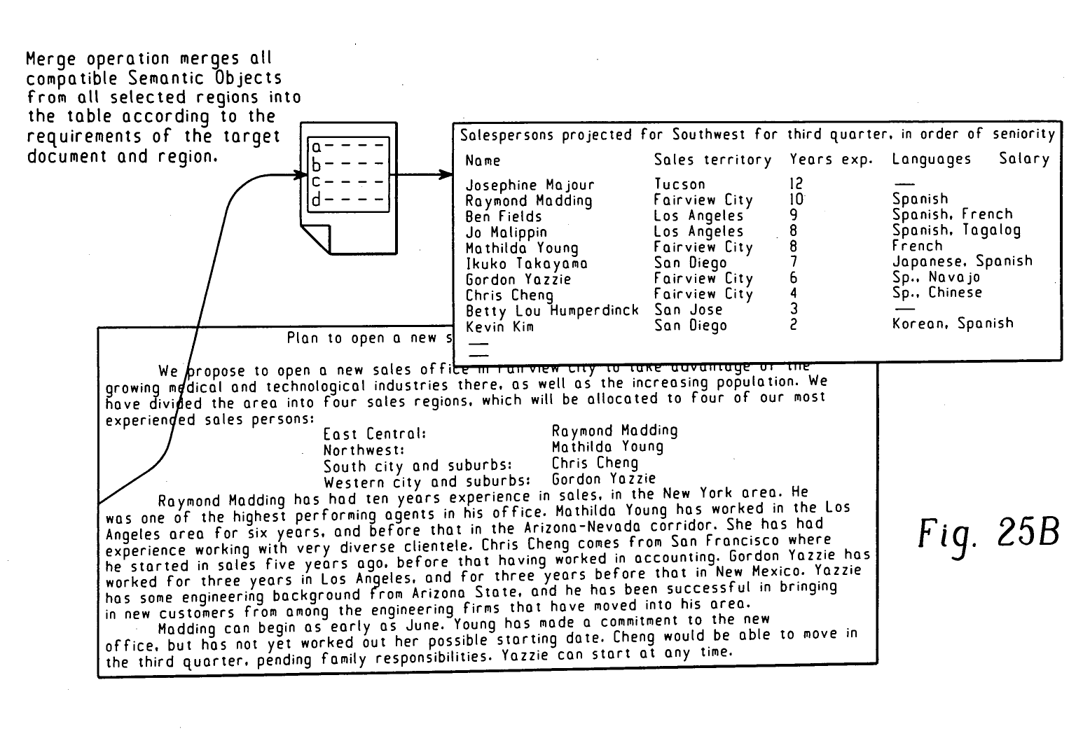

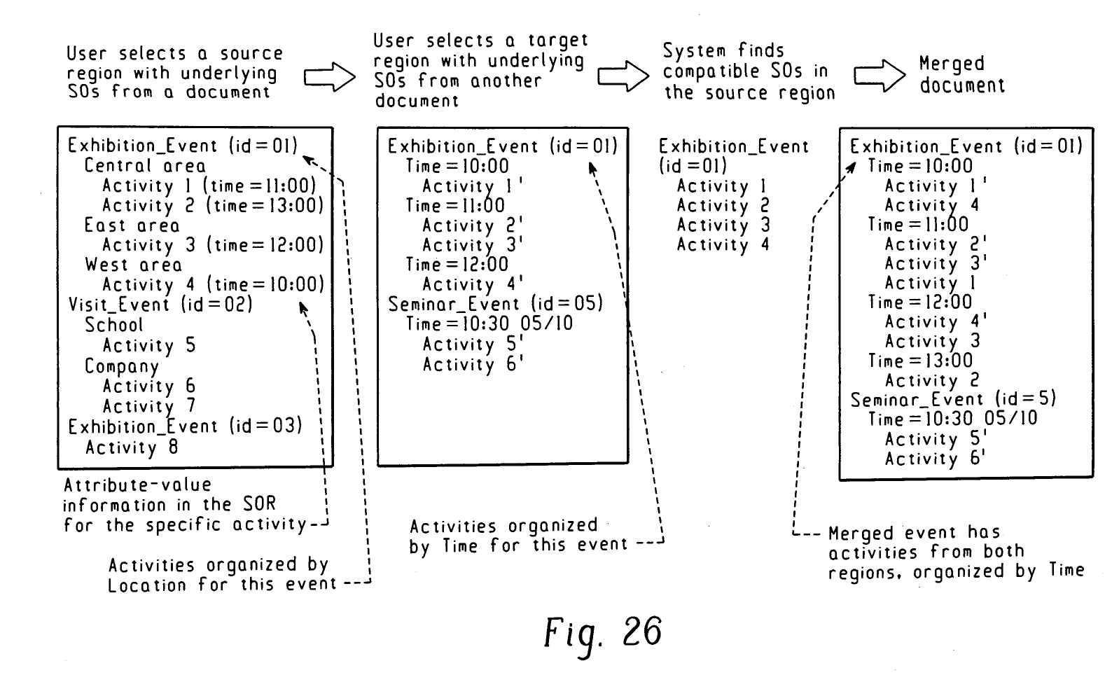

FIGS. 24, 25A, 25B, and 26 illustrate schematically various examples of the merge processes. FIG. 24 illustrates a merge between two semi-structured complex semantic objects. FIGS. 25A and 25B illustrates a merge of a textual document into a Semi-Structured CSO. FIG. 26 illustrates a merge of two CSOs.

The reader will recognize that the flowcharts presented herein do not reflect all possible conditions and circumstances that may arise when performing the various methods. Those of ordinary skill in the art will recognize that additional steps, procedures, etc., may be required to enable the methods to be practiced in a manner capable of dealing with atypical situations.

While the present invention has been described in conjunction with preferred embodiments thereof, those of ordinary skill in the art will recognize that many modifications and variations are possible. For example, the present invention may be implemented in connection with a variety of different hardware configurations. Additionally, actions such as “select”, “determine”, “define”, “retrieve”, “remove”, etc., should be understood broadly, and be understood as being capable of being performed manually by a user, in an automated manner by the system, or some combination of both. Also, the reader should understand the results of “selecting”, “determining”, “defining”, “retrieving”, “removing”, etc., may result in a zero or null result. Such meanings, modifications and variations fall within the scope of the present invention which is limited only by the following claims.

1. A semantically informed merge operation, comprising:
selecting a source region in a document and a target region in a document;
identifying a hi-directionally coupled surface region in said source region and a bi-directionally coupled surface region in said target region;
identifying a first semantic object coupled to said surface region in said source region and a second semantic object coupled to said surface region in said target region; and
combining said first semantic object with said second semantic object.

2. The method of claim 1 wherein said combining comprises one of merging or appending.

3. The method of claim 1 additionally comprising:
identifying a first plurality of bi-directionally coupled surface regions in said source region and a second plurality of bi-directionally coupled surface regions in said target region;
identifying a plurality of first semantic objects each coupled to one of said surface regions in said source region and identifying a plurality of second semantic objects each coupled to one of said surface regions in said target region; and
wherein said combining comprises iteratively combining each of said plurality of first semantic objects with each of said plurality of second semantic objects with which it is type compatible.

4. The method of claim 1 additionally comprising determining if said first semantic object is type compatible with said second semantic object, and if not, said combining comprising appending the said first semantic object to said second semantic object.

5. The method of claim 1 additionally comprising determining if said second semantic object is a complex semantic object, and if so, said combining including combining subcomponents of said first semantic object with subcomponents of said second semantic object if the first semantic object is complex, otherwise said combining comprising appending said first semantic object into the subcomponents of said second semantic object.

6. The method of claim 1 additionally comprising determining if said second semantic object is a complex semantic object, and if not, said combing comprising appending the first semantic object to the second semantic object.

7. The method of claim 1 additionally comprising:
identifying a first plurality of bi-directionally coupled surface regions in said source region and a second plurality of bi-directionally coupled surface regions in said target region;
identifying a plurality of first semantic objects each coupled to one of said surface regions in said source region and identifying a plurality of second semantic objects each coupled to one of said surface regions in said target region; and
wherein said combining comprises iteratively combining under the control of a user each of said plurality of first semantic objects with each of said plurality of second semantic objects with which it is type compatible.

8. A semantically informed merge operation, comprising:
selecting a plurality of regions from at least one document;
identifying a plurality of semantic objects bi-directionally coupled to surface regions in said selected regions;
combining said semantic objects; and
displaying attributes and values of at least one of the semantic objections coupled to a surface region according to a presentation constraint.

9. The method of claim 8 additionally comprising selecting a target region for the combined semantic objects.

10. The method of claim 9 wherein said selecting a target region includes selecting a target region having surface regions bi-directionally coupled to one or more of said semantic objects.

11. The method of claim 9 wherein said displaying according to a presentation constraint includes displaying according to a presentation constraint imposed by the selected target region.

12. The method of claim 9 additionally comprising selecting a source region, and wherein said selected target region includes selecting a point or a blank, said combining including copying said selected source region into said target region.

13. The method of claim 8 wherein said combining is restricted to type-compatible semantic objects.

14. The method of claim 8 wherein said displaying is performed according to a presentation constraint derived from one or more of said semantic objects.

15. The method of claim 8 wherein said combining comprises iteratively combining sub-components of said semantic objects.

16. The method of claim 15 additionally comprising updating values of the combined semantic objects.

17. The method of claim 8 wherein said combining is ordered according to the complexity of the semantic objects.

18. The method of claim 17 wherein said combining is ordered such that complex semantic objects depending upon or consisting of other semantic objects are combined first.

19. The method of claim 17 wherein said combining is ordered by reference to an Ontology.

20. A semantically informed merge operation, comprising:
selecting a source region in a document and a target region in a document;
identifying semantic objects bi-directionally coupled to surface regions in said selected target region;
making a list of said identified semantic objects;
receiving from a user a type of merge to be performed between semantic objects in the source region and semantic objects on said list; and
combining said semantic objects according to the user selected type of merge.

21. The method of claim 20 wherein said combining terminates when said list of semantic objects is exhausted.

22. The method of claim 20 wherein said receiving from a user includes receiving one of a merge first type, a merge all type, or a merge select type.

23. The method of claim 20 wherein said combining is ordered according to one of the complexity of the objects, the order in which the objects are encountered, the properties of the objects, the ranking of the objects, or an Ontology.

24. The method of claim 23 wherein in the event of a tie in the ordering of said combining, said tie is broken by comparing the size of the surface regions of the respective semantic objects.

25. A computer readable medium storing a set of instructions for performing a semantically informed merge operation, comprising:
selecting a source region in a document and a target region in a document;
identifying a bi-directionally coupled surface region in said source region and a bi-directionally coupled surface region in said target region;
identifying a first semantic object coupled to said surface region in said source region and a second semantic object coupled to said surface region in said target region; and
combining said first semantic object with said second semantic object.

26. A computer readable medium storing a set of instructions for performing a semantically informed merge operation, comprising:
selecting a plurality of regions from at least one document;
identifying a plurality of semantic objects bi-directionally coupled to surface regions in said selected regions;
combining said semantic objects; and
displaying attributes and values of at least one of the semantic objections coupled to a surface region according to a presentation constraint.

27. A computer readable medium storing a set of instructions for performing a semantically informed merge operation, comprising:
selecting a source region in a document and a target region in a document;
identifying semantic objects bi-directionally coupled to surface regions in said selected target region;
making a list of said identified semantic objections;
receiving from a user a type of merge to be performed between semantic objections in the source region and semantic objects on said list; and
combining said semantic objects according to the user selected type of merge.
